(19) United States
(12) Patent Application Publication
(10) Pub. No.: US 2026/0087702 A1
(43) Pub. Date: Mar. 26, 2026

(54) Systems and methods for generating digital images

(71) Applicant: Canva Pty Ltd, Surry Hills (AU)

(72) Inventor: Danny Wu, South Turramurra (AU)

(73) Assignee: Canva Pty Ltd, Surry Hills (AU)

(21) Appl. No.: 19/289,061

(22) Filed: Aug. 3, 2025

(30) Foreign Application Priority Data
Sep. 23, 2024 (AU) 2024219980

(51) Int. Cl. G06T 11/60

(52) U.S. Cl. CPC G06T 11/60

(57) ABSTRACT

Described herein is a computer implemented method. The method includes determining a first set of objects, wherein each object in the first set of objects is associated with an object-image and a position and processing the first set of objects to generate a first image-raster. The first image-raster incorporates each object-image that is associated with an object in the first set of objects, and each object-image is positioned in the first image-raster based on the position of the object that the object-image is associated with. The method further includes generating a first digital image by processing the first image-raster using a trained image generation model.

### CROSS REFERENCE TO RELATED APPLICATION

This application is a U.S. Non-Provisional application that claims priority to Australian Patent Application No. 2024219980, filed Sep. 23, 2024, which is hereby incorporated by reference in its entirety.

### TECHNICAL FIELD

Certain aspects of the present disclosure are directed to systems and methods for generating digital images.

### BACKGROUND

Various computer applications for creating digital images exist.

As one example, design generation applications exist that allow users to create a design by selecting design elements and adding those design elements to a page. Once a design has been created, such applications will typically also provide mechanisms for the design to be displayed and output—e.g. to be saved, shared, published, or otherwise output.

### SUMMARY

Described herein is a computer implemented method including: determining a first set of objects, wherein each object in the first set of objects is associated with an object-image and a position; processing the first set of objects to generate a first image-raster, wherein the first image-raster incorporates each object-image that is associated with an object in the first set of objects and each object-image is positioned in the first image-raster based on the position of the object that the object-image is associated with; and generating a first digital image, wherein generating the first digital image includes processing the first image-raster using a first machine learning model, and wherein the first machine learning model is a trained image generation model.

Also described herein is a computer implemented method including: displaying, on a display, a user interface including a virtual generation surface; detecting a first user interaction adding a first object to the virtual generation surface at a first position, wherein the first object is a prompt object and the first user interaction includes user input that defines first prompt text for the first object; resolving the first object to a first resolved image based on the first prompt text; generating a first layer-image based on the first resolved image, wherein the first layer-image includes first image content that corresponds to the first resolved image, and wherein the first image content is positioned in the first layer-image at a position that is based on the first position of the first object on the virtual generation surface

### BRIEF DESCRIPTION OF THE DRAWINGS

In the drawings:

FIG. 1 is a diagram depicting a networked environment in which various features of the present disclosure may be implemented.

FIG. 2 is a block diagram of a computer processing system configurable to perform various features of the present disclosure.

FIG. 3 depicts an example image generation user interface.

FIG. 4 is a flowchart depicting operations performed in a computer implemented method for generating a digital image.

FIG. 5 depicts partial user interface.

FIG. 6 is a flowchart depicting operations performed in a computer implemented method for resolving a prompt to an actual element.

FIG. 7 is a flowchart depicting operations performed in a computer implemented method for generating a layer-image.

FIG. 8 provides depictions of a virtual generation surface, an image, a text-raster, and a combined image-text-raster.

FIG. 9 is a flowchart depicting operations performed in a computer implemented method for generating a digital image.

FIG. 10 provides example states of a partial user interface used to generate digital images.

FIG. 11 is a flowchart depicting operations performed in a computer implemented method for generating a digital image.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure is directed to systems and methods for creating digital images. In particular, the present disclosures provides mechanisms for a user to create a digital images based on actual elements, element prompts, or a combination of actual elements and element prompts.

In the context of the present disclosure, reference to a digital image is reference to an image that can be rendered (e.g. displayed) and saved by a computer processing system. The present disclosure refers to two types of digital images in particular: design-format images (referred to as designs for convenience) and raster-format images (referred to as rasters for convenience).

In the context of the present disclosure, a design is an image that is made up of a set of design elements. Generally speaking, each design element has a size and position and can be selected and manipulated separately from each other design element. For example, by use of an appropriate application, each design element of a design can be separately selected and manipulated (e.g. moved, resized, or otherwise edited). As one example, a design may include two raster image elements and an application may allow a user to select one of those image elements and move, resize, or edit it independently of the other image element.

In the context of the present disclosure, reference to a raster is reference to a raster image. Generally speaking, a raster image is made up of a set of pixel values (e.g. RGB or other colour scheme values). Unlike a design, a raster image does not inherently permit selection and manipulation/editing of individual components in the image (though a raster image may be processed—e.g. via segmentation techniques or the like-to identify pixels that belong to individual segments or objects within the image).

In some cases, a design and a raster may look the same once rendered. This will be the case, for example, if a design is processed (e.g. rasterised) to generate a corresponding raster. In this case, though, the underlying data defining the design (e.g. a set of elements with associated element data) will be different to the underlying data defining the raster (e.g. a set of pixel values).

In the context of the present disclosure, reference to an actual element is reference to an existing visual element. This may, for example, be a raster element (e.g. a photo or other raster-format element), a graphic element (e.g. a vector graphic element), a text box (e.g. an element used to display text), or an alternative type of visual element. In this disclosure, an actual (existing) existing visual element may be contrasted with a generated element (which is an element that is generated based on prompt and/or other data).

In the context of the present disclosure, reference to an element prompt is reference to text that is processed in order to retrieve or generate a visual element.

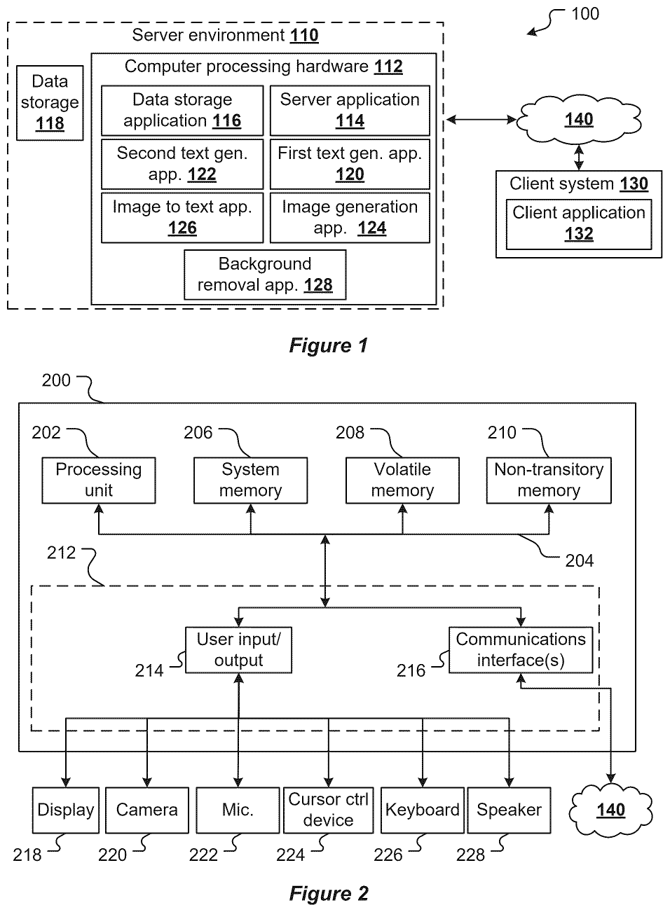

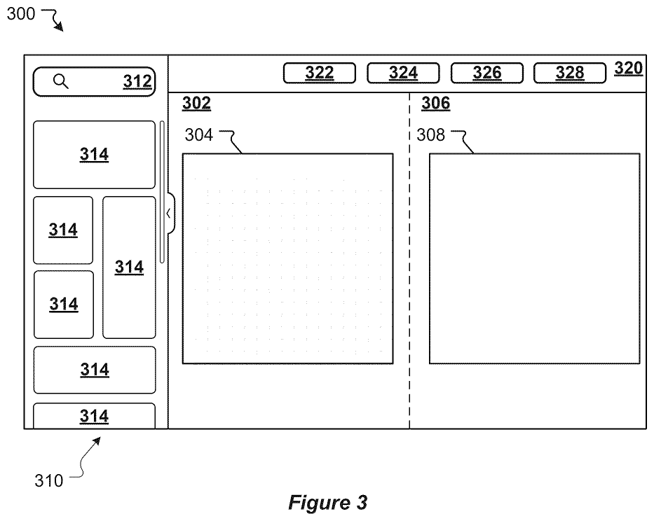

The techniques disclosed herein are necessarily implemented by one or more computer processing systems. While various system architectures and configurations are possible, the disclosure will be described predominantly in the context of a digital design platform that makes use of a client-server architecture. To this end, FIG. 1 depicts an example networked environment 100 in which various features of the present disclosure may be implemented.

Networked environment 100 includes a server environment 110 which serves one or more client systems such as client system 130. Server environment 110 and client system(s) 130 communicate via one or more communications networks 140 (e.g. the Internet).

Generally speaking, the server environment 110 includes computer processing hardware 112 (discussed below) on which one or more server-side applications execute in order to provide server-side functionality to client applications such as client application 132 (described below).

In the present example, server environment 110 includes a server application 114. In the present example, the server application 114 executes to provide a client application endpoint that is accessible over communications network 140. Generally speaking, the server application 114 functions to receive data from client applications, perform various processing (and processing coordination) functions, and communicate data back to client applications. Where server application 114 serves web browser client applications, the server application 114 will be a web server which receives and responds (for example) to HTTP requests. Where server application 114 serves native client applications, server application 114 will be an application server configured to receive, process, and respond to specifically defined API calls received from those client applications. The server environment 110 may include one or more web server applications and/or one or more application server applications allowing it to interact with both web and native client applications.

In the present example, server application 114 (and/or other applications of server environment 110) facilitates various functions related to designs and images. These may include, for example, design/image creation, editing, storage, organisation, searching, storage, retrieval, viewing, sharing, publishing, and/or other functions related to digital designs and images. The server application 114 (and/or other applications) may also facilitate additional, related functions such as user account creation and management, user group creation and management, user and user group permission management, user authentication, and/or other server side functions.

In the present example, server environment 110 also includes a data storage application 116 which executes to receive and process requests to persistently store and/or retrieve data relevant to the operations performed/services provided by the server environment 110. Such requests may be received from the server application 114, other server environment applications, and/or (in some instances) directly from client applications such as 132. Data relevant to the operations performed/services provided by the server environment 110 may include, for example, user account data, design data (i.e. data describing designs that have been created by users), image data, template design data (e.g. templates that can be used by users to create designs), design element data (e.g. data in respect of existing design elements that users may add to designs), and/or other data relevant to the operation of the server environment 110.

The data storage application 116 may, for example, be a relational database management application or an alternative application for storing and retrieving data from data storage 118. Data storage 118 may be any appropriate data storage device (or set of devices), for example one or more non-transitory computer readable storage devices such as hard disks, solid state drives, tape drives, or alternative computer readable storage devices.

In server environment 110, server application 114 persistently stores data to data storage device 118 via the data storage application 116. In alternative implementations, however, the server application 114 may be configured to directly interact with data storage devices such as 118 to store and retrieve data (in which case a separate data storage application may not be needed). Furthermore, while a single data storage application 116 is described, server environment 110 may include multiple data storage applications. For example one data storage application 116 may be used for user account data, another for user design data, another for design element data and so forth. In this case, each data storage application may interface with one or more shared data storage devices and/or one or more dedicated data storage devices, and each data storage application may receive/respond to requests from various server-side and/or client-side applications (including, for example server application 114).

In the present example, server environment 110 includes a first text generation application 120 which takes a text string as input (potentially with additional inputs defining operational parameters) and generates a text string output. In the described embodiments, the first text generation application 120 is (or makes use of) a trained machine learning model (which may be referred to as a first trained machine learning model). For example, the first text generation application 120 may be (or make use of) a large language model (LLM) such as a generative pre-trained transformer (GPT). The first text generation application 120 may be (or make use of) a machine learning model that is specifically trained for the operations described herein (see below), or may be (or make use of) an existing pre-trained machine learning model, for example a model such as ChatGPT, Bard, or an alternative text generation model.

In the present example, server environment 110 includes a second text generation application 122 which takes a text string and one or more images as input (potentially with additional inputs defining operational parameters) and generates a text string output. In the described embodiments, the second text generation application 122 is (or makes use of) a trained machine learning model (which may be referred to as a second trained machine learning model). For example, the second text generation application 122 may be (or make use of) a vision-language model (VLM)—for example a GPT 4 model or an alternative model. The second text generation application 122 may be (or make use of) a machine learning model that is specifically trained for the operations described herein (see below) or may be (or make use of) an existing pre-trained machine learning model, for example a model such as ChatGPT.

In alternative embodiments, rather than making use of two separate text generation applications as depicted, a single text generating application may be provided that is trained to generate a text string based on either a text input or combined text and image inputs.

In the present example, server environment 110 also includes an image generation application 124 which takes an image and/or a text string as input (potentially with additional inputs defining operational parameters) and generates an image output (e.g. a raster image). In the described embodiments, image generation application 124 is (or makes use of) a trained image generation machine learning model. For example, image generation application 124 may be (or make use of) a generative adversarial network (GAN) model, a variational autoencoder (VAE) model, a latent diffusion model, a mixed-modal auto-regressive transformer model, or an alternative image generation model. Image generation application 124 may be (or make use of) a machine learning model that is specifically trained for the operations described herein (see below), or may be (or make use of) an existing pre-trained machine learning model, for example a model such as Stable Diffusion, DALL-E, CLIP, Chameleon, or an alternative image generation model.

In the present example, server environment 110 includes an image to text application 126 which takes an image as input (potentially with additional inputs defining operational parameters) and returns a text description (or a caption) that describes the content of the input image. In the described embodiments, image to text application is (or makes use of) a trained machine learning model such as a Bootstrapping Language-Image Pre-training (BLIP), a VLM, ChatGPT, or other trained image captioning model.

In the present example, server environment 110 includes a background removal application 128 which takes an image as input (potentially with additional inputs defining operational parameters) and returns what will be referred to as a background-removed image as output. In this context, a background-removed image is a version of an input that either has background pixels removed or includes a mask or other data (e.g. alpha channel data or a transparency layer) that can be used to identify/render background pixels as transparent. Any appropriate background removal application 128 may be used. In the described embodiments, background removal application is a trained machine learning model, for example an object segmentation model (e.g., Segment Anything Model, remove.bg model), a mixed-modal auto-regressive transformer model, or an alternative model.

In certain embodiments, each of applications 120, 122, 124, 126, and 128 is (or makes use of) a separate trained machine learning model. In other embodiments, however, the functionality of two or more of these applications may be provided by a single machine learning model. One example of such a model is a mixed-modal auto-regressive transformer model (e.g., Chameleon). In this case, and by way of example, the single trained machine learning model may be used (with appropriate prompts and other inputs) to perform the functionality of the first text generation application 120, the second text generation application 122, the image generation application 124, the image to text application 126, and the background removal application 128.

Furthermore, while applications 120, 122, 124, 126, and 128 are described and depicted as being part of the server environment 110, the functionality provided by one or more of these applications may instead be provided by one or more applications executing at a remote server environment—for example via server(s) and application(s) that offer text generation, image generation, text captioning, and/or background removal as a service.

As noted, the server environment 110 applications run on (or are executed by) computer processing hardware 112. Computer processing hardware 112 includes one or more computer processing systems. The precise number and nature of those systems will depend on the architecture of the server environment 110.

For example, in one implementation each server environment application may run on its own dedicated computer processing system. In an alternative implementation, two or more server environment applications may run on a common/shared computer processing system.

Communication between the applications and computer processing systems of the server environment 110 may be by any appropriate means, for example direct communication or networked communication over one or more local area networks, wide area networks, and/or public networks (with a secure logical overlay, such as a VPN, if required).

In the present example, client system 130 hosts a client application 132 which, when executed by the client system 130, configures the client system 132 to provide client-side functionality/interact with server environment 110 (or, more specifically, the server application 114 and/or other applications provided by the server environment 110).

Client application 132 operates to generate a (or multiple) user interfaces which are displayed to a user (via a display). Client application 132 also operates to receive user inputs (via the user interfaces and one or more input devices). Such user inputs are detected and processed by the client application 132 and, in some instances, cause the client application 132 to communicate data to the server environment 110.

The client application 132 may be a general web browser application which accesses the server application 114 via an appropriate uniform resource locator (URL) and communicates with the server application 114 via general world-wide-web protocols (e.g. http, https, ftp). Alternatively, the client application 132 may be a native application programmed to communicate with server application 114 using defined application programming interface (API) calls and responses.

A given client system such as 130 may have more than one client application 132 installed and executing thereon. For example, a client system 130 may have a (or multiple) general web browser application(s) and a native client application.

The present disclosure describes various operations that are performed by applications of the server environment 110 and client application 132. Generally speaking, however, operations described as being performed by a particular application (e.g. server application 114) could be performed by (or in conjunction with) one or more alternative applications, and/or operations described as being performed by multiple separate applications could in some instances be performed by a single application.

While the embodiments of the present disclosure are described in the context of a client-server architecture, the techniques and processing described could be adapted to be executed in a stand-alone context—e.g. by an application (or set of applications) that run on a computer processing system and can perform all required functionality without need of a server environment or application.

The techniques and operations described herein are performed by one or more computer processing systems.

By way of example, client system 130 may be any computer processing system which is configured (or configurable) by hardware and/or software—e.g. client application 132—to offer client-side functionality. A client system 130 may be a desktop computer, laptop computer, tablet computing device, mobile/smart phone, or other appropriate computer processing system.

Similarly, the applications of server environment 110 are executed by one or more computer processing systems (the computer processing hardware 112). Server environment computer processing systems will typically be server systems, though again may be any appropriate computer processing systems.

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204, the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, the connection between the device and system 200 may be via wired or wireless hardware and communication protocols, and may be a direct or an indirect (e.g. networked) connection.

Generally speaking, and depending on the particular system in question, devices to which system 200 connects include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

As another example, where system 200 is a server computing device it may be remotely operable from another computing device via a communication network. Such a server may not itself need/require further peripherals such as a display, keyboard, cursor control device etc. (though may nonetheless be connectable to such devices via appropriate ports).

Alternative types of computer processing systems, with additional/alternative input and output devices, are possible.

System 200 also includes one or more communications interfaces 216 for communication with a network, such as network 140 of environment 100 (and/or a local network within the server environment 110). Via the communications interface(s) 216, system 200 can communicate data to and receive data from networked systems and/or devices.

System 200 stores or has access to computer applications (which may also referred to as computer software or computer programs). Generally speaking, such applications include computer readable instructions and data which, when executed by the processing unit 202, configure system 200 to receive, process, and output data. Instructions and data can be stored on non-transitory machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server environment 110 includes one or more systems which server-side applications 114, 116, 120, 122, 124, 126, and 128. Similarly, client system 130 runs a client application 132.

Turning to FIG. 2, an example image generation user interface (UI) 200 will be described. In the present embodiments, UI 200 is generated by client application 132 (referred to as application 132 for convenience) and displayed on a display (e.g. a touch screen or other display such as 218) of the client system 130.

UI 300 includes a generation region 302 which, in this example, a user interacts with in order to generate a digital image. In this example, the generation region 302 includes what will be referred to as a virtual generation surface 304 (or surface 304 for convenience). As described further below, application 132 allows a user to generate a digital image by adding objects (including actual elements and/or element prompts) to the surface 304. In this particular example the surface 304 is displayed with gridlines however this need not be the case. Generally speaking, a virtual generation surface may be any user interface region or area that a user can add objects to (as discussed below).

UI 300 also includes a preview region 306 which is used to display a digital image 308. In particular, application 132 generates a digital image based on the objects that have been added to the surface 304 and displays that digital image 308 in the preview region 306.

In the present example, a dotted line is shown as dividing the generation and preview regions 302 and 306—such a line need not actually be displayed. Furthermore, while in the present example the generation and preview regions 302 and 306 are displayed side-by-side (and at the same time) in the same UI, this need not be the case. Instead, the generation region 302 may be displayed in one UI and the preview region 306 may be displayed in a separate UI. In this case, the generation and preview regions 302 and 306 may still be displayed at the same time (albeit in separate UIs), or they could be displayed one at a time: e.g. the application may automatically switch between the UIs or allow a user to select which UI is displayed.

UI 300 also includes an element search region 310. Element search area 310 may be used, for example, to search for design elements that application 132 makes available to a user to assist in creating a digital image. Different types of elements may be made available, for example template text elements (with different text format attributes), vector graphic elements (such as geometric shapes and/or other vector graphics), raster elements (such as stock photos or other raster images), chart elements, table elements, and/or other types of design elements.

In this example, search area 310 includes a search control 312 via which a user can enter and submit search text (e.g. a string of characters). In response to a user submitting search text, client application 132 may perform a search and display previews 314 (e.g. thumbnails or the like) of any search results.

Application 132 may be configured to search for design elements at (and retrieve design elements/previews thereof from) various locations. For example, the search functionality invoked by search control 312 may cause application 132 to search for design elements that are stored in locally accessible memory of the system 130 on which application 132 executes (e.g. memory such as 210 or other locally accessible memory), design elements that are stored at a remote server environment such as 110 (and searched/retrieved via a server application such as 114), and/or design elements stored on other locally or remotely accessible devices.

GUI 300 also includes an additional controls area 320 which, in this example, is used to display additional controls. The additional controls may include one or more: permanent controls (e.g. controls such as save, download, print, share, publish, and/or other controls that are frequently used/widely applicable and that application 132 is configured to permanently display); user configurable controls (which a user can select to add to or remove from area 320); and/or one or more adaptive controls (which application 132 may change depending, for example, on the type of design element that is currently selected/being interacted with by a user). For example, if a text element is selected, application 132 may display adaptive controls such as font style, type, size, position/justification, and/or other font related controls may be displayed. Alternatively, if a vector graphic element is selected, application 132 may display adaptive controls such as fill attributes, line attributes, transparency, and/or other vector graphic related controls may be displayed. By way of example, a save control 322, share control 324, and publish control 326 may be provided which allow a user to save, share, and/or publish the digital image that is displayed in the preview region 306. In certain embodiments, a generate image control 328 may also be displayed (the operation of which is described below).

Once a digital image has been generated, application 132 may provide various options for outputting that digital image. For example, application 132 may provide a user with options to output a digital image by one or more of: saving the digital image to local memory of system 130 (e.g. memory 210); saving the digital image to remotely accessible memory device; saving the digital image at a server environment such as 110; sending the digital image to a printer (local or networked) for printing; communicating the digital image to another user (e.g. by email, instant message, or other electronic communication channel); publishing the digital image to a social media platform or other service (e.g. by sending the digital image to a third party server system with appropriate API commands to publish the digital image); and/or by other output means.

As noted above, reference to a design in the present specification is reference to set of design elements. Various design data formats are possible. In order to illustrate designs (as opposed to rasters), this section provides a simplified example of a design data format. Alternative design data formats (which make use of the same or alternative design attributes) are, however, possible, and the processing described herein can be adapted for alternative design formats.

In the present example, data in respect of a particular design is stored in a design record which includes a set of key-value pairs (e.g. a map or dictionary). Generally speaking, the design record defines certain design-level attributes and includes design element data (or element data for short). To assist with understanding, a partial example of a design record format is as follows:

| Attribute | Example |
|---|---|
| Design ID | “designId”: “abc123” |
| Dimensions | “dimensions”: {“width”: 1080, “height”: 1080} |
| Background | “background”: {“mediaID”: “M12345”} |
| Element data | “elements”: [{element 1}, . . . {element n}] |

In this example, the design-level attributes include: a design identifier (which uniquely identifies the design); dimensions (e.g. a design width and height; background (data indicating any background that has been set, for example an identifier of an image that has been set as the background, data indicating a colour or colour gradient that has been set as a background, or data indicating an alternative background); and element data (discussed below).

In this example, a design's element data is a set (in this example an array) of element records. Each element record defines an element that has been added to the design. In this example, the element data is ordered and an element record's position in the set serves to identify the element and the depth or z-index of the element. For example, an element at array index n is positioned above an element at array index n−1 and below an element at array index n+1. Element depth may be alternatively handled, however, for example, by storing depth as an explicit element attribute.

Furthermore, in this particular example a design's background (if any) is defined in a design-level attribute. In alternative examples, a background may be defined via an element record in the design's element data. Where the order of element records is used to define depth a background (if any) may be defined by the first element of the element data (e.g. index 0). Alternatively, the element record in respect of the background may be provided with a particular flag or other attribute indicating it is the background.

Generally speaking, an element record defines an object that has been added to the design—e.g. by copying and pasting, importing from one or more element libraries (e.g. libraries of images, element types, animations, videos, etc.), drawing/creating using one or more design tools (e.g. a text tool, a line tool, a rectangle tool, an ellipse tool, a curve tool, a freehand tool, and/or other design tools), or by otherwise being added to a design.

Different types of design elements may be provided for depending on the system in question. The present disclosure is particularly concerned with visual design elements which may include, for example, vector graphic elements, raster image elements, video elements, text elements, and/or elements of other types of visual media.

In the present example, example, elements are associated with position and size data. One example of an element record for an element that is used to display a raster image is as follows:

| Attribute | Note | E.g. |
|---|---|---|
| Type | A value defining the type of the element. | “type”: “RASTER” |
| Position | Data defining the position of the element: e.g. an (x, y) | “position”: (100, 100) |
| | coordinate pair defining (for example) the top left point | |
| | of the element. | |
| Size | Data defining the size of the element: e.g. a (width, | “size”: (500, 400) |
| | height) pair. | |
| Rotation | Data defining any rotation of the element. | “rotation”: 0 |
| Opacity | Data defining any opacity of the element (or element | “opacity”: 1 |
| | group). | |
| Media | Data indicating the media (e.g. an image) that the | “mediaID”: “M12345” |
| identifier | element holds/is used to display | |

Different attributes may be appropriate for different types of elements. For example, an element record for an element that is used to display text (e.g. a text-box or a text type element) may also include attributes such as:

| Attribute | Note | E.g. |
|---|---|---|
| Type | A value defining the type of the element. | “type”: “TEXT”, |
| Position | Data defining the position of the element. | “position”: (100, 100) |
| Size | Data defining the size of the element. | “size”: (500, 400) |
| Rotation | Data defining any rotation of the element. | “rotation”: 0 |
| Opacity | Data defining any opacity of the element. | “opacity”: 1 |
| Text | Data defining the actual text characters | “text”: “Trip” |
| Attributes | Data defining attributes of the text (e.g. font, font size, | “attributes”: {. . .} |
| | font style, font colour, character spacing, line spacing, | |
| | justification, and/or any other relevant attributes) | |

The storage location for design data (e.g. design records) will depend on implementation. For example, in the networked environment described above design records are (ultimately) stored in/retrieved from the server environment's data storage 118. Alternatively, or in addition, design data may be locally stored on a client system 130 (e.g. in memory 210 thereof).

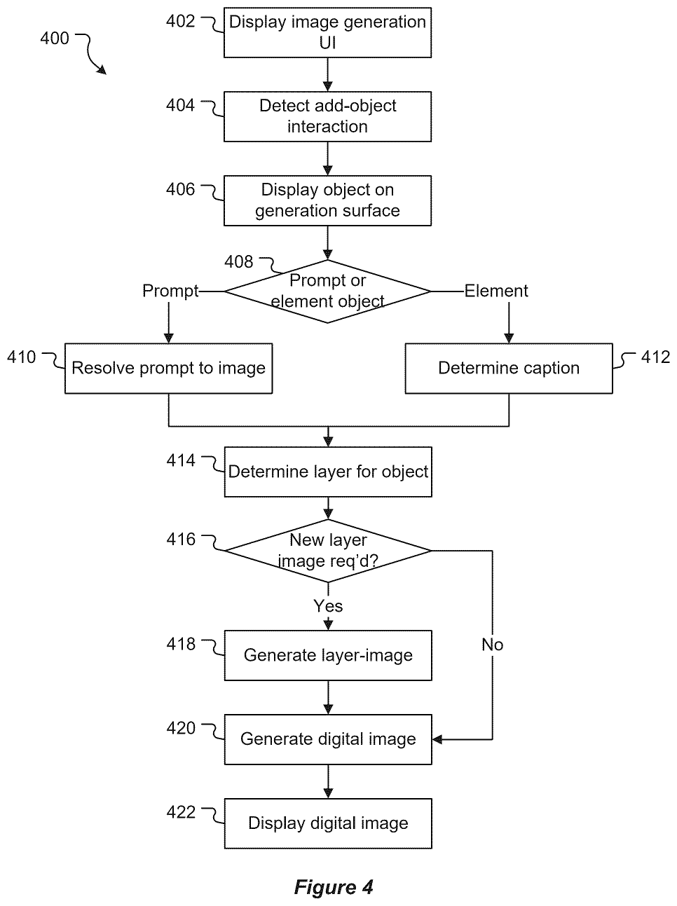

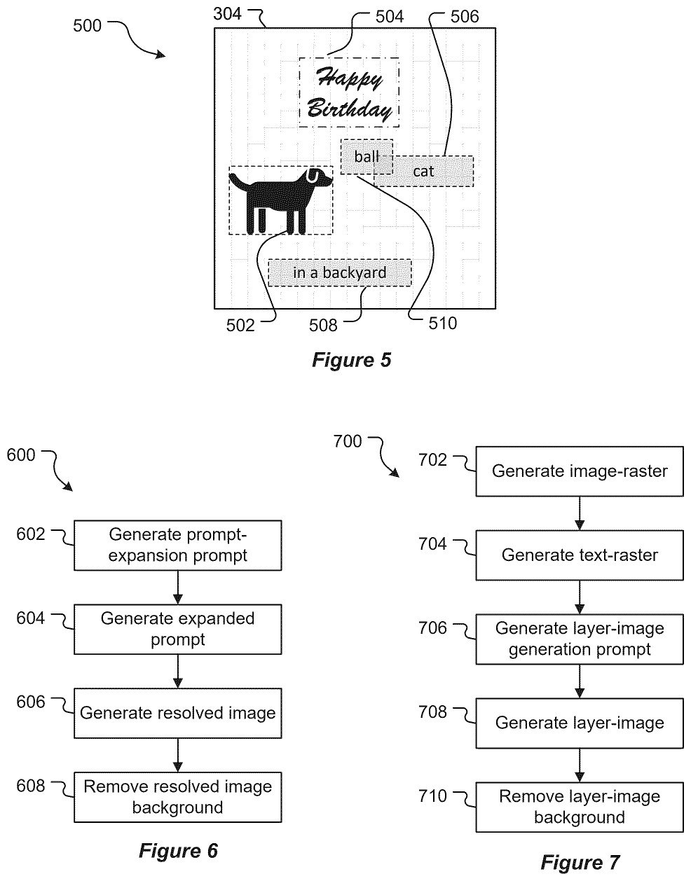

Turning to FIG. 4, a computer implemented method 400 for generating a digital image will be described. Certain processing blocks of method 400 will be described with reference to the example partial user interface 500 of FIG. 5 (which depicts the surface 304 of example UI 300 described above).

Method 400 will be described with particular processing being performed by particular applications. In alternative embodiments, however, processing that is described as being performed by a particular application may be performed by one or more alternative applications running on the computer processing hardware 112 of the server environment 110, the client system 130, and/or other computer processing systems.

In method 400, client application 132 operates to display a user interface (and various other display objects) and to detect user inputs. Where client application 132 displays a user interface (and/or other display objects) it does so via one or more displays that are connected to (or integral with) system 100—e.g. display 218. Where client application 132 operates to receive or detect user input, such input is received or detected via one or more input devices that are connected to (or integral with) client system 132—e.g. a touch screen, a touch screen display 218, a cursor control device 224, a keyboard 226, and/or an alternative input device.

At 402, client application 132 displays an image generation UI. Method 400 will be described with reference to the example image generation UI 300 described above, but alternative user interfaces are possible.

At 404, client application 132 detects a user interaction that adds an object to a virtual generation surface (e.g. surface 304 of UI 300). This will be referred to as an add-object interaction (and it may include one or more user inputs).

In the present embodiment, client application 132 is configured to permit two types of add-object interactions. These will be referred to as an add-actual-element interaction and an add-element-prompt interaction. These are described in turn below.

In the present embodiment, an add-actual-element interaction is an interaction in which a user adds an object that corresponds to an actual element to a particular position on the surface 304. The actual element may, for example, be an image (which may be a raster or a vector graphic image), a text element, or an alternative visual element. An object corresponding to an actual element may be referred to as an element object. In the present examples, and as described below, an element object may more specifically be an image object (where it corresponds to an image) or a text object (where it corresponds to a text element).

As one example, an add-actual-element interaction may involve a user submitting a search via a search control such as 312. In response, images that match the search are identified (which may include raster and/or vector graphic images) and client application 132 displays previews of those images (such as previews 314). Searching may be performed by the server application 114 and involve communications between the client application 132 and server application 114. The user may then select a particular image (via its preview 314), drag it to a particular position on the surface 304, and drop it on the surface 304 at that position. This causes an object corresponding to the particular image (which may be referred to as an image object) to be generated and (at 406) displayed on the surface 304. In the present embodiment, an image object (that corresponds to a particular image) is generated to take the appearance of the particular image (or a preview of the particular image).

To further illustrate this example, a user may submit a search string such as “dog” via search control 312 (or otherwise browse for existing “dog” elements). In response, “dog” images are identified and client application 132 displays previews 314 thereof in element search region 310. A user can then drag a particular preview onto the generation pane 304.

As another example, an add-actual-element interaction may involve a user searching or browsing for template text elements. In response, different template text elements are identified—for example a level 1 heading text element, a level 2 heading text element, a paragraph text element, or an alternative text element (each different template text element having different default format attributes such as font type, font size, font colour, alignment, and/or other text format attributes). Client application 132 then displays previews 314 of the template text elements in element search region 310. A user can then drag one of those text element previews onto the surface 304. This causes an object corresponding to the selected text element (which may be referred to as a text object) to be generated and (at 406) displayed on the surface 304. Where a text element is added, the corresponding text object that is displayed at 406 may initially include default text associated with the text element (which may, for example, be text such as “Level 1 heading” or the like). A user may then interact with the text object to edit the default text as desired, though need not do so (in which case the default text remains).

As another example, an add-actual-element interaction may involve a user interacting with a particular position on the canvas (e.g. via a specified user input such as a right click, a dwell gesture, or an alternative interaction). This interaction may be referred to as a secondary interaction. In response to the interaction the client application 132 may display a further user interface (or user interface elements) via which a user can search or browse for visual elements and select a particular visual element. In this case, the further user interface may allow a user to search or browse locally accessible visual elements (e.g. stored on local memory such as 210) and/or remotely accessible visual elements (e.g. visual elements available through a remote storage device or content server). On user input selecting a visual element client application 132 may then add an element object corresponding to the selected visual element at the particular position on the canvas.

In the present embodiment, an add-element-prompt interaction causes an object corresponding to a user prompt (which will be referred to as a prompt object) to be added to the surface 304 at a particular position. In the present embodiments, an add-element-prompt interaction includes an add component (that adds a prompt object to the surface 304) and a define component (which defines the text of the prompt).

As one example, the add component of an add-element-prompt interaction may involve a user interacting with a particular position on the canvas (e.g. via a specified user input such as a left click, a tap gesture, or an alternative interaction). This interaction may be referred to as a primary interaction. In response to the interaction the client application 132 displays (at 406) a prompt object at the particular position on the canvas. The prompt object may, for example, be a text entry box permitting text entry. The define component of the add-element-prompt interaction then involves the user defining specific text for the prompt that is being added. This may involve a user typing text into the prompt object that is displayed, speaking words into a microphone (such as 222) which client application 132 then converts to text and adds to the prompt object that is displayed, or otherwise defining text for the prompt.

At 406, and as noted above, the object that is added via the add-object interaction detected at 404 is displayed on the surface 304. In the present embodiment: an image object (corresponding to an actual image) is displayed as the actual image that the object corresponds to; a text object (corresponding to actual text) is displayed as the actual text that the object corresponds to (which may be default text or user defined text); a prompt object (corresponding to a user prompt) is displayed as the actual prompt text defined by the user.

In the present embodiment, when an object is added to the surface 304 the client application 132 is configured to add the object as the top-most object (i.e. highest z-index or depth) by default and to display the object accordingly.

Once an object has been added to (and displayed on) the surface 304, client application 132 may be configured to permit various interactions with the object. In some instances, a user may interact with an object before the remaining processing of method 400 is performed (in which case the results of such interactions are taken into account in the processing of method 400). In other instances, a user may interact with an object after the remaining processing of method 400 has been performed (and, as such, a digital image is generated and displayed based on the original—pre-interaction—version of the object). In this case, the further interaction with the object is processed according to method 900 described below.

As one example, a user may interact with an object to move it (that is, change its two-dimensional position) on the surface 304. This may involve, for example clicking on or contacting the object (e.g. a primary interaction), dragging it to a new position, and releasing it.

As another example, a user may interact with an object to resize it. This may involve, for example, a user selecting an edge or a handle of a bounding box displayed for the object and moving the edge or handle as desired.

As another example, a user may interact with an object to change its depth. For example, in response to a right click or dwell gesture (e.g. a secondary interaction) on an object client application 132 may display a menu that provides a user with various options in respect of the object. Such menu options may include depth adjustment options which allow a user to change the depth of the object (e.g. a bring forward option, a send backward option, a bring to front option, a send to back option).

As another example, where the object is an element object a user may interact with the object to change one or more attributes of the element object. This functionality may, for example, be provided by options in a menu as discussed above (which may be displayed in response to a secondary interaction with an object). The adjustment options available will depend on the type of the actual element that the element object corresponds to. For example, if the object is an image object that corresponds to a vector graphic, then attributes that can be changed may include line and/or fill colour changes of one or more components of the vector graphic (and/or changes to other vector graphic attributes). Alternatively, if the object is an image object that corresponds to a raster, then attributes that can be changed may include attributes corresponding to parameters such as contrast, brightness, saturation, tint, and/or other raster image parameters. As a further example, if the object is a text object, then attributes that can be changed may include attributes corresponding to one or more text format attributes (e.g. font type, font size, font style, font colour, and/or other text format attributes) and/or a change to the actual text that is to be displayed.

As another example, where the object is a prompt object, a user may interact with the prompt object to edit the prompt text—e.g. by clicking or contacting the object and entering text.

To illustrate displaying objects on the surface 304, partial UI 500 of FIG. 5 shows a surface 304 where four objects have (progressively) been added by add-object interactions. These include: image object 502 (added first), which corresponds to an image (e.g. a vector graphic or an image) of a dog that has been added; text object 504 (added second), which corresponds to a text element that has been added (and for which a user has replaced any default text with the text “Happy Birthday”); prompt object 506 (added third), which is a prompt that has been added and that a user has defined the prompt text of “cat” for; prompt object 508 (added fourth), that a user has defined the prompt text of “in a backyard” for; and prompt object 510 (added fifth), which is a prompt that has been added and that a user has defined the prompt text of “ball” for.

In partial UI 500, client application 132 has displayed the objects so that text object 504 (which corresponds to a text element) is visually distinguished from prompt objects 506, 508, and 510. In this specific example, text object 504 is displayed with a dot-dash line bounding box (and no fill) while prompt objects 506 and 508 and 510 are displayed with a dash-dash-dash line bounding box (and a partially transparent grey fill). Alternative techniques for visually distinguishing text objects from prompt objects may be used, for example by use of different line colours, different line types, different fill colours, different fill patterns, and/or other visual techniques.

As indicated at 408, if the object that has been added at 404 is a prompt object processing proceeds to 410. If it is an element object processing proceeds to 412.

At 410, a prompt object has been added. In this case, the prompt text of the prompt object is resolved to an image—which is referred to as the resolved image for the prompt object. In the present embodiments the resolved image is a raster image (which may include an alpha channel or transparency layer which causes any background of the resolved image to be rendered transparently). Resolution of a prompt object to a resolved image may be done in various ways, examples of which are described below with reference to FIG. 6. Following resolution of the prompt object to a resolved image processing proceeds to 414.

At 412, an element object has been added. In this case a caption is determined for the element object at 404.

In the present embodiments, if the element object is a text object, the caption is determined to be the actual text of that text object. This may be default text inherited from the text element the object corresponds to (e.g. “Heading 1” or other default text, depending on the object) or the text entered by a user for the text object.

If the element object is an image object, the caption may be determined in various ways.

In some instances, an element object may correspond to an image that is associated with metadata that includes descriptive text of the image. In this case, that metadata may be used as the caption for the image object. For example, an image of a dog may include a metadata attribute such as “Caption: Dog”. If metadata such as this exists, then that caption may be used for the image object (though in other instances a caption may nonetheless be generated as discussed below if desired—for example to try and provide consistency between captions rather than relying on metadata).

If the image that an image object corresponds to is not associated with relevant metadata, a caption is generated. In the present embodiment, server application 114 coordinates generation of a caption using the image to text application 126 which, as described above, may be a trained image captioning machine learning model. In this case, server application 114 provides the image that the image object corresponds to as input to the image to text application 126 (potentially with a prompt, if required) which returns a caption for the image—e.g. a short textual description of the subject of the image. In certain cases, and depending on the image and the image to text application 126, server application 114 may need to process the image before providing it as input to the image to text application 126. For example, if the image to text application 126 takes a raster as input, but the image in question is a vector graphic, server application 114 is configured to rasterise the vector graphic and then provide the rasterised vector graphic as input to the image to text application 126.

In the present embodiment captions are not determined for prompt objects. Rather, if a caption is needed for the prompt object the prompt text itself may be used (or text based thereon).

Following 410 and 412, an object that has been added to the surface 304 is associated with both an image and a caption. These may be referred to as an object-image and an object-caption. For an image object, the object-image is the image itself and the object-caption is the caption determined at 412; for a text object, the object-image is an image of the actual text and the object-caption is the actual text (or text based thereon) (determined at 412); for a prompt object, the object-image is the resolved image generated for the prompt (at 410) and the object-caption is the prompt text (or text based thereon).

At 414, a layer is determined for the object (e.g. the actual element or the prompt) that has been added at 404. In the present embodiment, determination of an object's layer is performed by the server application 114. This could, however, be done by the client application 132 (or an alternative application).

Server application 114 is configured to determine a particular layer for an object from a set of predefined layers. The set of predefined layers includes two or more predefined layers that have a specific depth (or z-index) order.

By way of example, the set of predefined layers may include three layers: a background layer (at depth 0, or the rearmost layer); a text layer (at depth 1, immediately above the background layer); and a foreground layer (at depth 2, or immediately above the text layer). As an alternative example, the set of predefined layers may include three layers may include: a far background layer (at depth 0); a near background layer (at depth 1); a midground layer (at depth 2); a text layer (at depth 3); and a foreground layer (at depth 4). As a further alternative example, the set of predefined layers may include two layers: a background layer (at depth 0) and a text layer (at depth 1). Other sets of predefined layers are possible.

Server application 114 may be configured to determine the particular layer for an object in various ways.

In the present embodiments, the set of predefined layers includes a dedicated text layer. In this case, server application 114 assigns any text object (corresponding to a text element) to the text layer. Each other object (e.g. image objects and prompt objects) are processed further to determine a layer and assign the object to that layer.

In one example, server application 114 may make use of a machine learning model (e.g. a classifier) that is programmed to automatically classify non-text objects into one of the predefined layers. Such a model may be trained to classify an object as belonging to a particular layer based on the object-caption, the object-image, or both. In the present embodiment, and as described above: for a prompt object, the object-caption is the text of the prompt as entered by the user (or text based thereon) and the object-image is the object's resolved image; for an image object, the object-caption is the caption determined at 412 and the object-image is the image (or a preview of the image) of the actual element that the object-image corresponds to. Where a machine learning model is used to determine an object's layer any appropriate machine learning architecture may be used (for example a convolutional neural network) and the model may be trained based on an appropriate training dataset that includes numerous images (and/or their associated text) and the predefined layer(s) those images most frequently appear in.

In an alternative example, server application 114 may make use of natural language processing techniques and a set of heuristic rules to determine the layer for an object based on the caption (and/or other text) associated with each object. By way of simple example, and assuming a set of layers that includes a background layer, text layer, and foreground layer as described above, server application 114 may be configured such that: if an object correspond to an text element, it is associated with the text layer; if an object's associated text indicates the object corresponds to a background element (e.g. based on the specific words and/or the grammar of the associated caption), it is associated with the background layer; otherwise the object is associated with the foreground layer.

As yet a further example, and in the example set of layers above which include a background layer and a text layer, server application 114 may assign all objects corresponding to text elements to the text layer and all other objects to the background layer.

In certain embodiments, the depths of objects within a layer (referred to as the intra-layer depth) are determined. In this case, intra-layer depth is based on the depth of the objects on the surface 304. As discussed above, in the present embodiments when an object is added to the surface 304 it is added as the top-most object, however a user may manually change the depth of an object. To illustrate layer and intra-layer depths, for the five objects that have been added to example UI 500 of FIG. 5, the server application 114 may assign layers and intra-layer depths as follows:

| | Depth on | | Intra-layer |
|---|---|---|---|
| Object | gen. surface | Layer assigned | depth |
| 502 (added initially) | 0 | Foreground (layer 2) | 0 |
| 504 (added second) | 1 | Text (layer 1) | 0 |
| 506 (added third) | 2 | Foreground (layer 2) | 1 |
| 508 (added fourth) | 3 | Background (layer 0) | 0 |
| 510 (added fifth) | 4 | Foreground (layer 2) | 2 |

If, however, a user had adjusted the depth of the “ball” prompt object after adding it (e.g. in a send to back operation), application 114 would adjust the intra-layer depths for the foreground layer objects as follows:

| | Depth on | | Intra-layer |
|---|---|---|---|
| Object | gen. surface | Layer assigned | depth |
| 502 (added initially) | [symbol] 1 | Foreground (layer 2) | [symbol] 1 |
| 504 (added second) | [symbol] 2 | Text (layer 1) | 0 |
| 506 (added third) | [symbol] 3 | Foreground (layer 2) | [symbol] 2 |
| 508 (added fourth) | [symbol] 4 | Background (layer 0) | 0 |
| 510 (added fifth, | [symbol] 0 | Foreground (layer 2) | [symbol] 0 |
| sent-to-back) | | | |

In alternative embodiments, intra-layer depths need not be tracked/determined.

At 416, server application 114 determines if generation of a new layer-image is required. In the present embodiments, generation of a new layer-image is required if the layer determined at 414 is anything other than the text layer. If generation of a new layer-image is required, processing proceeds to 418. If not, processing proceeds to 420.

At 418, server application 114 generates a layer-image. In particular, server application 114 generates a layer-image for the predefined layer that the object added at 404 has been assigned to (at 414). Generally speaking, generation of a layer-image for a selected layer involves generating a single raster that is based on all objects that have been assigned to the selected layer. An example method 700 for generating a layer-image for a selected layer is described below. Following generation of the layer-image processing proceeds to 420.

At 420, server application 114 generates a digital image that corresponds to the objects that have been added to the surface 304. Generally speaking, the digital image is generated by composing the layer-images that have been generated and (in the present embodiment) the objects that have been assigned to the text layer into a single digital image based on the depth order of the predefined layers. This may be done in various ways.

In the present embodiment, sever application 114 creates a design-format image at 420. To do this, sever application 114 generates a design element (which will be referred to as a layer-element) corresponding to each non-text layer and generates a set of text-type design elements that includes a text-type design element corresponding to each text object that has been added to the surface 304.

To generate a layer-element that corresponds to a selected non-text layer, and with the example design data format described above, server application 114 creates an element record and associates that element record with the layer-image that has been generated (at 418) for the selected layer (e.g. via the element's “media” attribute). If no objects that have been added to the surface 304 have been assigned to the selected layer then no layer-image will have been generated for that layer and it is ignored. Each layer-image that has been generated should be the same size (e.g. a default design size) and when generating a layer-element server application 114 may set size and position data for the element that causes the layer-image to occupy the entirety of the design. For example, the position data may be (0,0) and the size data may include the width and height of the design itself.

To generate the set of text-type design elements, server application 114 processes each text object that has been added to the surface 304 and generates a corresponding text-type design element. For a selected text object, server application 114 generates the corresponding design element to have a size and position that are based on the size and position of the object in the surface 304. In some instances, and depending on the size of the surface 304, the size and position of a text-type design element will be the same as the size and position of the corresponding object. In other instances, the size and position of a text-type design element will be proportional to the size and position of the corresponding object. Other attributes of the text-type design element (including text formatting attributes, the actual text that is displayed, and any other relevant attributes) are taken from the text object (and, therefore, the original text element that the text object corresponds to). The depth order of the text-type design elements within the set of text-type design elements is based on the depths of the corresponding objects on the surface 304.

Once layer-elements corresponding to each non-text layer have been generated, and the set of text-type design elements has been generated, server application 114 generates a new design. In the new design, the layer-elements and set of text-type design elements are arranged in depth order.

To illustrate this, consider the example above where there are three predefined layers: background layer (depth 0), text layer (depth 1), and foreground layer (depth 2). For the purposes of this illustration assume that server application has generated: a single layer-element corresponding to the background layer; a set of three text-type elements (T1, T2, and T3) which correspond to three text objects that have intra-layer depths of 0, 1, and 2 respectively; and a single layer-element corresponding to the foreground layer. To generate the design server application may generate an ordered set of elements as follows:

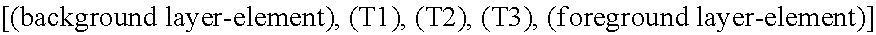

At 422, server application 114 causes the digital image generated at 420 to be displayed by the client application 132. To do this, server application 114 sends the digital image (or data in respect thereof) to the client application 132. On receipt, the client application 132 causes the digital image to be displayed. In this example, the digital image is displayed in the preview region 306 (e.g. as digital image 308).

Once the digital image has been generated and is displayed, a user may perform various actions. For example, client application 132 may provide various user interface controls via which a user can; save the digital image as a design-format image; save the digital image as a raster-format image (in which case client application 132 or server application 114 rasterises the design-format image); share the digital image (as a design-format or raster-format image); publish the digital image (as a design-format or raster-format image); and/or perform other operations on the digital image.

In the example described above, the digital image is generated in such a way that any text elements a user has added to the surface 304 are generated and included as editable text elements (i.e. not as rasterised versions thereof). An advantage of this is that a user may wish to interact with those text elements in the design-format digital image 308 that has been generated and is displayed in the preview region 306. For example, a user may select a particular text element in the digital image 308 and perform various actions such as: move the text element; resize the text element; change the depth of the text element (within the set of text elements or to bring the text element in front of a layer-element or send the text element behind a layer-element); change the text of the text element; change formatting attributes of the text element (e.g. font size, style, type, colour, and/or other format attributes); animate the text element; and/or perform other actions that are relevant to a text element. Notably, such interaction with the digital image that has been generated would not be possible if the image was generated as a raster-format image.

In alternative embodiments, however, server application 114 may generate the digital image at 420 in ways that do not maintain text elements as editable design elements. As one example, instead of generating a set of text-type design elements as described above, server application 114 may instead generate a layer-image for the text layer (i.e. a single raster image including all text elements) and then a single layer-element corresponding to the text layer (the layer-element associated with the text layer's layer-image). In this case, and returning to the above 3-layer example, server application will generate: a single layer-element corresponding to the background layer; a single layer corresponding to the text layer; and a single layer-element corresponding to the foreground layer. To generate the design server application would then generate the ordered set of elements as follows:

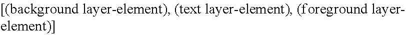

In addition to, or instead of, interacting with the digital image as displayed at 422, a user may “edit” the digital image by further interactions with the surface 304. For example, a user may add a further object to the surface 304, in which case processing according to process 400 repeats and results in a new digital image being generated at 420 and displayed at 422. Alternatively, a user may interact with an existing object on the surface 304, in which case processing according to a method such as method 900 (described below) may be performed. While adding a further object to the surface 304 and/or interacting with an existing object may be referred to as “editing” the digital image (or as resulting in the digital image being “edited”), such interactions actually cause generation and display of a new digital image.

At 410 of method 400 a prompt object that has been added in an add-object event is resolved to an image (referred to as the resolved image). Turning to FIG. 6, a method 600 for resolving a prompt to a resolved image will be described. In this embodiment, method 600 is performed at the server environment 110. To this end, the client application 132 communicates the prompt text of a prompt object to the server application 114 which coordinates resolution of the prompt to a resolved image. In other embodiments, however, prompt resolution may be performed by the client application 132 itself, or the client application 132 in conjunction with one or more other applications (remote or local to the client system 130).

At 602, server application 114 generates a prompt-expansion prompt: that is, a prompt that will be used to expand the text of the prompt.

In the present embodiment, server application 114 generates a prompt-expansion prompt that includes both a user text component (text that is or is based on the prompt text of the prompt object being processed) and a context component (text which provides additional context that is ultimately used to generate the prompt-expansion prompt). As one example, server application 114 may be configured to generate the prompt-expansion prompt by use of a prompt expansion template which includes the context component and to which the user text component is added. By way of specific example, the prompt expansion template may be a template such as:
“You are a prompt writer. Please generate a prompt of 50 words or less that will be used to generate an image by creating an expanded description of the text “<user text component>”.”

In this example, in order to generate the prompt-expansion prompt the server application 114 substitutes the “<user text component>” text in the template with the actual user text component.

At 604, server application 114 uses the prompt-expansion prompt generated at 602 to generate an expanded prompt. In the present embodiment server application 114 does so by processing the prompt-expansion prompt using the first text generation application 120. As discussed above, the first text generation application 120 takes text as input and generates text (in this particular instance an expanded prompt) as output.

In the present embodiment, server application 114 is configured to cause the first text generation application 120 to generate the expanded prompt using a fixed seed (and to use the same fixed seed each time an expanded prompt is generated). The fixed seed is an input or parameter that causes the first text generation application 120 to generate the same output each time the same input is provided. That is, instead of potentially generating two different expanded prompts in response to the same prompt-expansion prompt, use of the same fixed seed parameter results in the same expanded prompt being generated in response to the same prompt-expansion prompt.

To illustrate prompt expansion, consider an example where the text of a prompt object is “dog” (e.g. as for the object 506 in the example above). In this case (and with the example template above), the server would generate a prompt-expansion prompt of
“You are a prompt writer. Please generate a prompt of 50 words or less that will be used to generate an image by creating an expanded description of the text “cat”.”
   Processing this via the first text generation application 120 may then result in the following expanded prompt being generated
“A fluffy, orange tabby cat with bright green eyes, lounging on a windowsill bathed in warm sunlight. The cat's fur glows softly in the light, and its tail is curled around its body.”

At 606, the server application 114 processes the expanded prompt using the image generation application 124. This causes the image generation application 124 to generate an initial image (e.g. a raster image) based on the prompt. This image may be referred to as the resolved image.

In the present embodiment, server application 114 is configured to cause the image generation application 124 to generate the resolved image using a fixed seed (and to use the same fixed seed each time a resolved image is generated). The fixed seed input is a parameter that causes the image generation application 124 to generate the same output each time the same input is provided. That is, instead of potentially generating two different resolved images in response to the same expanded prompt, use of the same fixed seed parameter results in the same resolved image being generated in response to the same expanded prompt. The fixed seed used for the image generation application 124 need not be the same fixed seed used for the first text generation application 120.

At 608, and if necessary, the server application 114 processes the resolved image to remove any background. To do this, server application 114 processes the resolved image generated at 606 using background removal application 128. This results in a background-removed version of the resolved image which is then returned/used as the resolved image.

It will be appreciated that resolving the prompt text of a prompt object to an image may be performed in alternative ways.

For example, the server application 114 may resolve the prompt text to an image by performing a search of existing visual elements. Such a search may be based on the prompt text or an expanded prompt (as described at 604). For example, server application 114 may perform a search based on the prompt text (or expanded prompt text) and select a specific visual element (e.g. the visual element with the highest/most favourable search score) which is returned by the search to be the resolved visual image.

As another example, the image generation application 124 may be capable of generating images that do not have any background. In this case, background removal processing at 608 may not be necessary (though server application 114 may be configured to generate an expanded prompt that explicitly includes an instruction to generate an image without a background or with a transparent background).

At 418 of method 400 a new layer-image is generated for a selected layer. Turning to FIG. 7, a method 700 for generating a layer-image will be described. In this embodiment, method 700 is performed at the server environment 110, with server application 114 orchestrating the process. In other embodiments, however, layer-image generation may be performed by the client application 132 itself, or the client application 132 in conjunction with one or more other applications (remote or local to the client system 130).

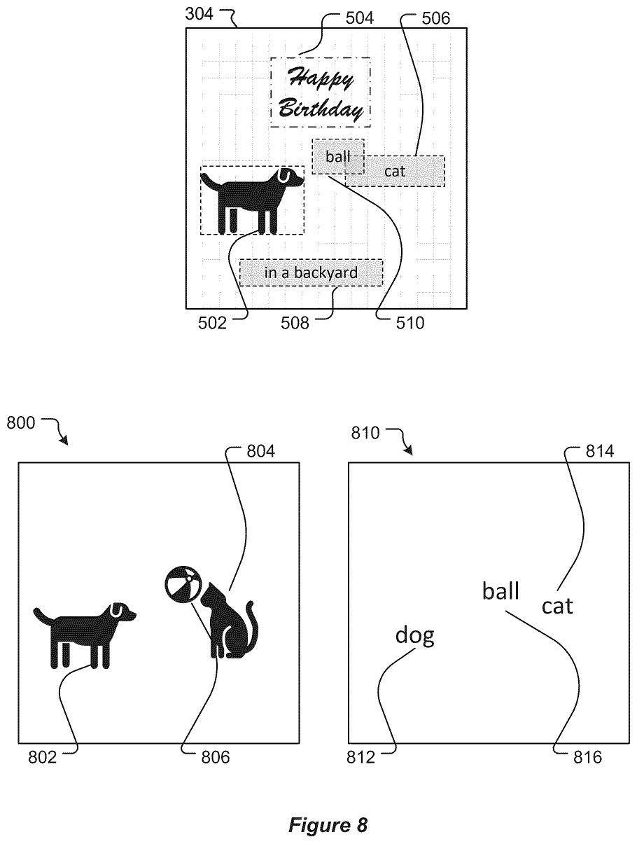

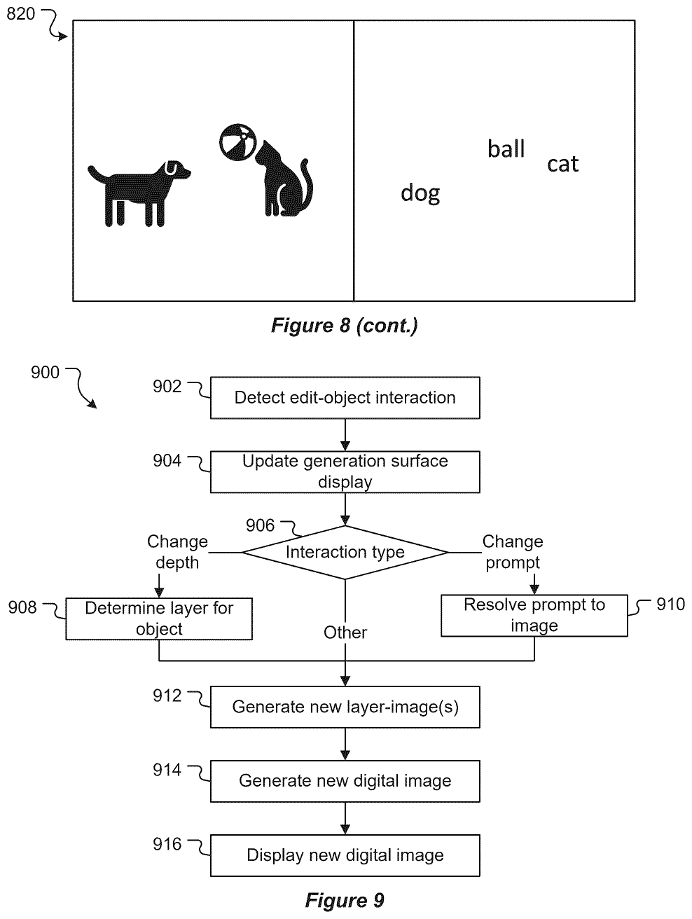

At 702, server application 114 generates what will be referred to as an image-raster for the selected layer. To generate the image-raster, server application 114 determines all objects that have been assigned to the selected layer and generates a raster that is based on the object-images associated with each of those objects. In the image-raster, the position of each object-image is based on, and corresponds to, the position of the associated object on the surface 304. In the image-raster, the size of each object-image may be determined in various ways. For example, for an object-image that is an actual image object, the size of the object-image may be the size of the image object itself (noting that a user may resize an image object after adding it to the surface 304). For an object-image that is a resolved image generated for a prompt, the object-image may be generated at a fixed sized and (optionally) resized. For example, an object-image may be resized based on: the size of a corresponding prompt object's text or bounding box (which a user may resize after adding to the surface 304); heuristic approaches (e.g. predefined heuristic rules based on one or more factors such as object identity, object importance, relative object size, object location, canvas size, etc.); machine learning based approaches; or a combination of such approaches. Furthermore, and as noted, a user may manually resize object-images (or the image objects or prompt objects they correspond to) to override any automatic resizing. An example of generating an image-raster is described further below with reference to FIG. 8.

At 704, server application 114 generates what will be referred to as a text-raster for the selected layer. In order to generate the text raster, server application 114 determines all objects that have been assigned to the selected layer and generates a raster that is based on the text of the object-captions associated with each of those objects. In the text-raster, each object caption is used to generate a text item (the text item being the text of the object-caption or text based thereon). The position of each text item based on the position of the object that the text item corresponds to on the surface 304.

Turning to FIG. 8, an example of generating an image-raster (at 702) and a text-raster (at 704) will be described.

FIG. 8 depicts the surface 304 of FIG. 5, and the example will be in respect of generating image and text-rasters corresponding to the foreground layer (to which objects 502, 506, and 510 have been assigned).

FIG. 8 also depicts an image-raster 800 that corresponds to the foreground layer of surface 304. Image-raster includes object-images 802, 804, and 806 which correspond respectively to foreground layer objects 502, 506, and 510. Object 502 is an image object and therefore the corresponding object-image 802 is (in this example) that image (the actual dog graphic). Object 506 is a prompt object (with the text “cat”), and therefore the corresponding object-image 804 is the resolved image for that prompt (an image of a cat). Object 510 is a prompt object (with the text “ball”), and therefore the corresponding object-image 806 is the resolved image for that prompt (an image of a ball). Image-raster 800 is a single raster and as such although object-images 802, 804, and 806 are individually referenced they are simply pixels of the image-raster, not distinct objects/images

FIG. 8 also depicts a text-raster 810 that corresponds to the foreground layer of surface 304. Text-raster includes text items 812, 814, and 816 which correspond respectively to foreground layer objects 502, 506, and 510. Object 502 is an image object, and therefore the corresponding text item 812 is based on the object-caption for object 502 (in this example the word “dog”). Object 506 is a prompt object (with the text “cat”), and therefore the corresponding text item 814 is based on the object-caption for object 502 (which, in this example, is the prompt text as entered by the user: the word “cat”). Object 510 is a prompt object (with the text “ball”), and therefore the corresponding text item 816 is based on the object-caption for object 510 (which, in this example, is the prompt text as entered by the user: the word “ball”). Text-raster 810 is a single raster and as such although text items 812, 814, and 816 are individually referenced they are simply pixels of the text-raster, not distinct objects/images.

At 706, server application 114 generates a layer-image generation prompt: that is, a prompt that will (in due course) be used to generate the new layer-image for the selected layer. In the present embodiment server application 114 generates the layer-image generation prompt by using the second text generation application 122 with inputs that include a prompt input and at least one image input.

In the present example, the prompt input that is used to generate the layer-image generation prompt is a predefined text prompt that describes the task to be performed by the second text generation application 122. As one example, such text input may be:
“You are a prompt writer. Create a prompt that reflects a cohesive image that would have all these objects and that reflects the intentions of the prompts.”

In the present example, the image input that is used to generate the layer-image generation prompt is based on the image-raster generated at 702 and text-raster generated at 704. In one implementation, the image input is a single image-text-raster that includes (or combines) both the image-raster and the text-raster. An example of such an image-text-raster is raster 820 of FIG. 8, which is a single raster with the image and text-rasters positioned side-by-side. In alternative embodiments, the image-raster and text-raster may be provided as separate image inputs to the second text generation application 122.

In still further embodiments, the image input to the second text generation application 122 may include only the image-raster or only the text-raster.

To illustrate generation of the layer-image generation prompt, providing the example predefined text described above with combined image/text-raster 820 depicted in FIG. 8 as input to the second text generation application 122 may generate a layer-image generation prompt such as:
“A beautiful photo of a golden retriever dog on the left and a Bengal cat that is jumping and playing with a ball on the right.”

At 708, server application 114 generates a layer-image. In the present embodiment, server application 114 generates the layer-image by using the image generation application 124 with inputs that include the layer-image generation prompt generated at 704 and the image-raster generated at 702. The output of the image generation application 124 is then an image (referred to as the layer-image) that is based on those inputs.

In alternative embodiments, server application 114 may generate the layer-image at 708 based solely on the image raster generated at 702 or based solely on the text raster generated at 704. In this case, a layer-image generation prompt need not be generated at 706 or used as input to the image generation application 124 when generating the layer-image. Furthermore: if the layer-image is generated at 708 based solely on an image raster a text raster need not be generated at 704; and if the layer-image is generated at 708 based solely on a text raster an image text raster need not be generated at 702.

In the present embodiment, server application 114 is configured to cause the image generation application 124 to generate the layer-image using a fixed seed (and to use the same fixed seed each time a layer-image is generated). As discussed above, a fixed seed is a parameter that causes the image generation application 124 to generate the same output each time the same input is provided.

At 710, and if necessary, the server application 114 processes the layer-image to remove any background. To do this, server application 114 processes the layer-image generated at 708 using background removal application 128. This results in a background-removed version of the layer-image which is returned/used as the layer-image for the selected layer.

As will be appreciated, by generating a layer-image in this way the two-dimensional positions of the objects that have been assigned to the layer for which the image is generated are taken into account. To illustrate this, if a user places a first object at the bottom left corner of the generation pane 302 (e.g. a prompt object or an element object that is associated with a “dog” image) and a second object at the top right corner of the generation pane (e.g. a prompt object or an element object that is associated with a “cat image), and both those objects are assigned to the same layer, then the layer-image that is generated will depict a dog at the bottom left and a cat at the top right. If a user then changes the generation pane 304 so the first object is at the top right and the second object is at the bottom left, then the layer-image that is generated will depict a dog at the top right and a cat at the bottom left. This provides a user with an intuitive way of not only specifying the types of objects that the digital image is to include, but also specifying the relative positions of those objects in the digital image.

In alternative embodiments, and depending on the specific image generation application 124 (and/or the nature of the trained image generation model that application is or uses), actual object coordinates may be used as inputs to the image generation model at 708. For example, two-dimensional coordinates (e.g. (x,y) coordinate pairs) may be determined for each object based on its position on the surface 304 (e.g. coordinate pair indicating a centroid of the object or an alternative defined point such as the top-left corner). The object coordinates may then be used as input to the image generation application. For example, server application 114 may generate (or amend) the layer-generation prompt generated at 706 to incorporate the object coordinates.

As noted above, once at least one object has been added to surface 304 and a digital image has been generated (e.g. according to method 400), a user may interact with an existing object on the surface 304. This may be referred to as “editing” the existing digital image that has been generated and displayed and, in most cases, will appear to a user as if they are editing that digital image. From a processing perspective however, interacting with an existing object actually causes a new digital image to be generated and displayed.

Turning to FIG. 9 a computer implemented method 900 for generating a new digital image based on adjustment of an object on the surface 304 will be described. Method 900 is performed after a digital image has been generated and displayed. This may, for example, after an has been added to a surface 304 and, in response, a digital image has been generated and displayed (per method 400), or after an existing object on a surface 304 has been adjusted and, in response, a digital image has been generated and displayed (per method 900 itself).

At 902, client application 132 detects a user interaction with an object that has been displayed on a virtual generation surface (e.g. surface 304 of UI 300). This will be referred to as an edit-object interaction (and it may include one or more user inputs).

In the present embodiment, client application 132 is configured permit various edit-object interactions such as: a delete object user interaction (which involve a user selecting an object and deleting it); a move object interaction (which involves a user selecting an object and moving it to a new position on the surface 304); a change depth interaction (which involves a user selecting an object and altering its depth relative to other objects on the surface 304—e.g. by sending back, bringing forward, sending to back, bringing to front); a resize object interaction (which involves a user selecting an object and resizing it uniformly or non-uniformly, e.g. by moving a bounding box edge or handle that is displayed for the object); a change prompt interaction (which involves a user selecting a prompt object and changing the prompt text that has been entered); and a change actual element attribute operation (which involves a user selecting an element object—e.g. an image object or a text object—and changing one or more attributes of that relevant to that object). The attribute changes that may be made to an element object will depend on the type of the actual element the object corresponds to. For example, for an image object that corresponds to a vector graphic, then attributes that can be changed may include line and/or fill colour changes of one or more components of the vector graphic (and/or changes to other vector graphic attributes). Alternatively, for an image object that corresponds to a raster, then attributes that can be changed may include attributes corresponding to parameters such as contrast, brightness, saturation, tint, and/or other raster image parameters. As a further example, for a text object, then attributes that can be changed may include attributes corresponding to one or more text format attributes (e.g. font type, font size, font style, font colour, and/or other text format attributes) and/or a change to the actual text that is to be displayed by the text object.

At 904, client application 132 updates the display of the surface 304 in accordance with the edit-object interaction. For example: for a delete object user interaction, client application 132 deletes the selected object from the surface 304; for a move object, change depth, or resize object interaction, client application 132 moves, resizes, or changes the depth of the selected object in accordance with the user input; for a change prompt interaction, client application 132 displays the new prompt text; and for a change actual element attribute operation, client application 132 updates the appearance of the object according to the attribute change(s) that has/have been made.

As indicated at 906, different processing may be required depending on the type of edit-object interaction. In the present example: if the edit-object interaction is a change depth interaction, processing proceeds to 908; if the edit-object interaction is a change prompt interaction, processing proceeds to 910; otherwise, processing proceeds to 912.

At 908, the edit-object interaction is a change depth interaction. In this case, a layer is determined for the object that has been edited. This processing may be the same as (or similar to) the processing described above with reference to processing block 414. In many cases, changing the depth of an object on the surface 304 will not result in a new layer being determined for the object-however this may not always be the case. Changing the depth of an object on the surface 304 may, however, result in the object having a new intra-layer depth. If so, and intra-layer depth is maintained, the intra-layer depth of the object is updated (which may involve the intra-layer depths of other objects also being updated to accommodate the update).

Following determination of the layer (and, if determined, intra-layer depth) for the object processing proceeds to 912.

At 910, the edit-object interaction is a change prompt interaction. In this case, the edited prompt is resolved to a new resolved image for the object. Processing to resolve the edited prompt to a new resolved image may be the same as (or similar to) the processing described above—e.g. by using the edited prompt to generate a new image (as described with reference to method 600) or using the edited prompt to retrieve an existing image. In embodiments that generate an image using a fixed seed (e.g. at 606 above), the same fixed seed that is used to generate a resolved image at 410 is used to generate a resolved image at 910. Following resolution of the new prompt to a new resolved image, processing proceeds to 912.

At 912, and if required, one or more new layer-images are generated. In embodiments where text objects are assigned to a text layer, and the digital design is generated with editable text-type design elements corresponding to each text object,), one or more new layer-images will need to be generated unless the object that has been edited is a text object. In embodiments where text objects are not included in the digital design as editable design elements, one or more new layer-images will need to be generated in most (if not all) cases.

In most cases a new layer-image will only need to be generated for the layer that the object that has been edited belongs to. For example, if the object that has been edited belongs to the foreground layer, then a new layer-image for the foreground layer is generated. If the edits to the object result in a new layer being determined for that object (at 908), however, two new layer-images will need to be generated: one for the layer that the object has been newly assigned to and one for the layer that the object was previously assigned to (given the layer-image for the previously assigned layer will have been generated including the object which is no longer assigned to that layer). Processing to generate a (or each) layer-image may be the same as (or similar to) the processing described above with reference to method 700.

At 914, a new digital image is generated that corresponds to the objects on the surface 304. This includes the object that is edited at 902. Processing to generate the new digital image may be the same as (or similar to) the processing described above with reference to processing block 420.

At 916, the new digital image generated at 914 is displayed in place of the previously generated digital image (e.g. in preview region 306). Processing to display the new digital image may be the same as (or similar to) the processing described above with reference to processing block 422.

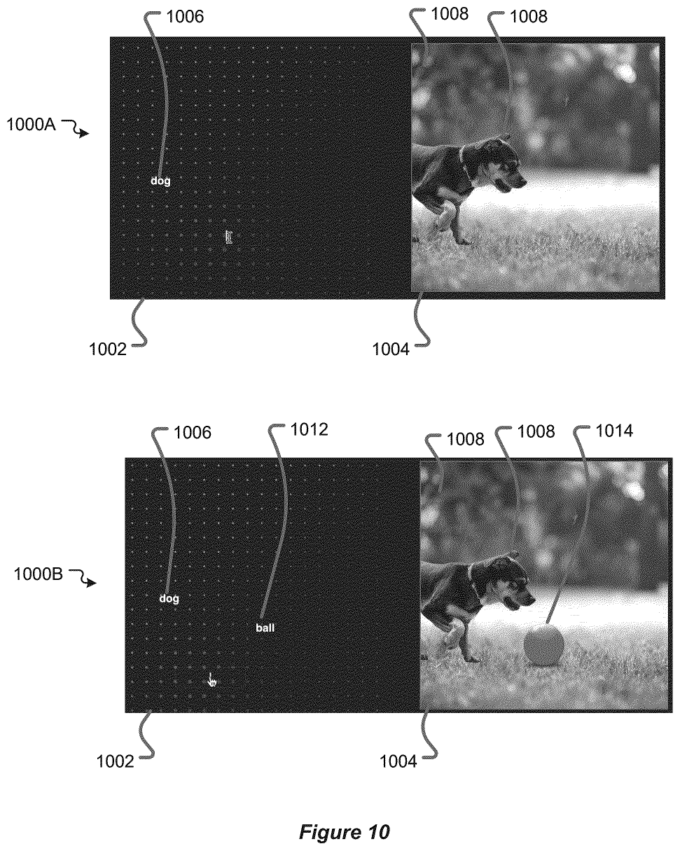

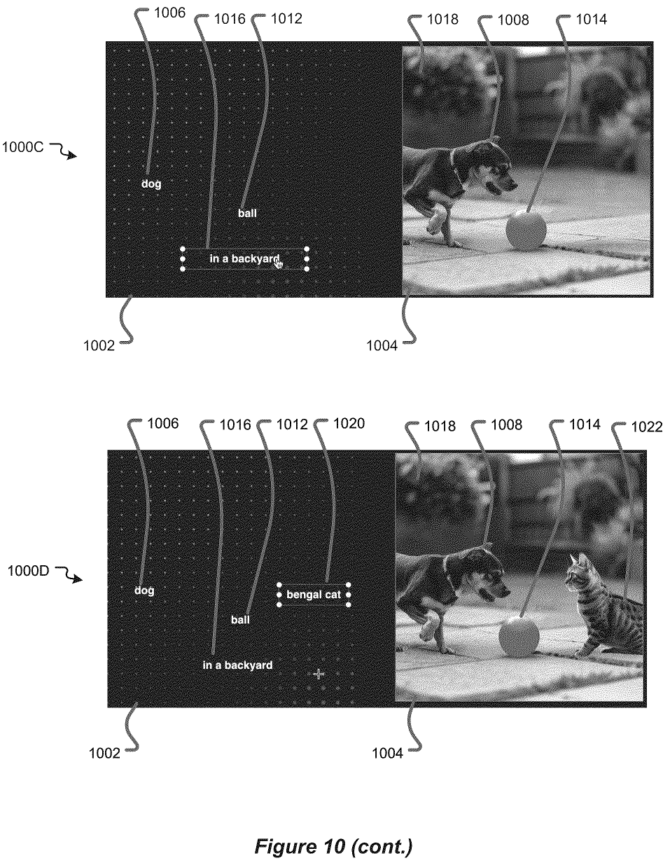

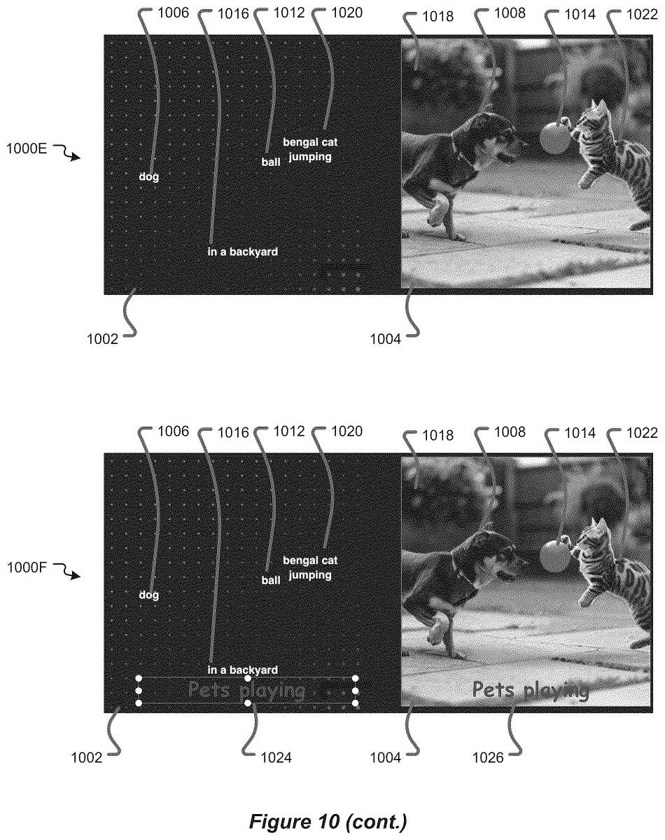

Turning to FIG. 10, an example in which several digital images are generated in accordance with the processing described above will be described. FIG. 10 depicts a partial user interface 1000 in several states (state 1000A to 1000F). In each state 1000A to F, partial UI 1000 includes a virtual surface 1002 and digital image 1004 that has been generated based on the objects that have been added to the virtual surface 1002.

In state 1000A, a user has added a single prompt object 1006 with the prompt text “dog” to the surface 1002 (via an add-element-prompt interaction). As a result of this user interaction: the prompt “dog” has been resolved to a resolved image at 410; object 1006 has been assigned to the foreground layer at 414; a new layer-image has been generated for the foreground layer 418; a digital image has been generated at 420; and the digital image 1004 has been displayed at 422. As can be seen, the image content of the digital image includes a dog 1008 corresponding to object 1006. In this particular instance, and as no object has been assigned to the background layer, server application 114 has not removed the background of the foreground layer-image at 710. As a result, the image 1004 that has been generated includes a “background” 1010 (though at this point the “background” may be part of the foreground layer). In other embodiments, however, the server application may remove the background of a layer-image even if no object has been assigned to the background layer. If this was done, then the “background” 1010 would not be visible in image 1004.

In state 1000B, a user has added a second prompt object 1012 with the prompt text “ball” to the surface 1002. As a result of this user interaction: the prompt “ball” has been resolved to a resolved image at 410; object 1012 has been assigned to the foreground layer at 414; a new layer-image has been generated for the foreground layer at 418; a new digital image has been generated at 420; and the new digital image 1004 has been displayed at 422. As can be seen, the image content of the new digital image includes the dog 1008 corresponding to object 1006 and a ball 1014 corresponding to object 1012.

In state 1000C, a user has added a third prompt object 1016 with the prompt text “in a backyard” to the surface 1002. As a result of this user interaction: the prompt “in a backyard” has been resolved to a resolved image at 410; object 1016 has been assigned to the foreground layer at 414; a new layer-image has been generated for the background layer at 418; a new digital image has been generated at 420 (incorporating both the pre-existing foreground layer-image and the new background layer-image); and the new digital image 1004 has been displayed at 422. As can be seen, the image content of the new digital image includes the dog 1008 corresponding to object 1006, the ball 1014 corresponding to object 1012, and a background 1018 corresponding to object 1016. As can also be seen, background 1018 has replaced the “background” 1010.

In state 1000D, a user has added a fourth prompt object 1020 with the prompt text “bengal cat” to the surface 1002. As a result of this user interaction: the prompt “bengal cat” has been resolved to a resolved image at 410; object 1020 has been assigned to the foreground layer at 414; a new layer-image has been generated for the foreground layer at 418; a new digital image has been generated at 420 (incorporating both the new foreground layer-image and the pre-existing background layer-image); and the new digital image 1004 has been displayed at 422. As can be seen, the image content of the new digital image includes the dog 1008 corresponding to object 1006, the ball 1014 corresponding to object 1012, the background 1018 corresponding to object 1016, and a cat 1022 corresponding to object 1020.

In state 1000E, a user has: adjusted the position of prompt object 1012 on the surface 1002 and edited the prompt text of prompt object 1020 (from “bengal cat” to “bengal cat jumping”). As a result of these user interactions: the prompt “bengal cat jumping” has been resolved to a resolved image at 910; a new layer-image has been generated for the foreground layer at 912 (taking into account edited objects 1012 and 1020); a new digital image has been generated at 914; and the new digital image 1004 has been displayed at 916. As can be seen, the image content of the new digital image includes: a dog 1008 corresponding to object 1006 (however the angle of the dog's head has now changed compared to the dog in states 1000A-D); a ball 1014 corresponding to object 1012 (noting that the ball has moved compared to its position in states 1000A-D); a background 1018 corresponding to object 1016; and a cat 1022 corresponding to object 1020 (noting that the cat is now jumping).

In state 1000F, a user has added a text object 1024 to the surface 1002. The text element that text object 1024 corresponds to (and, therefore, text object 1024 itself) has format properties that include purple colour text, 14 point size, bold, Comic Sans font. Further, the user has entered the text of “Pets playing” for the text object 1024. As a result of this user interaction: object 1020 has been assigned to the text layer at 414; a new text element has been generated for the text object at 420; a new digital image has been generated at 420 (incorporating, in back-to-front depth order: the pre-existing background layer-image; the new text element; the pre-existing foreground layer-image); and the new digital image 1004 has been displayed at 422. As can be seen, the image content of the new digital image includes: the dog 1008 corresponding to object 1006; the ball 1014 corresponding to object 1012; a background 1018 corresponding to object 1016; a cat 1022 corresponding to object 1020; and an editable text element 1026 corresponding to object 1024.

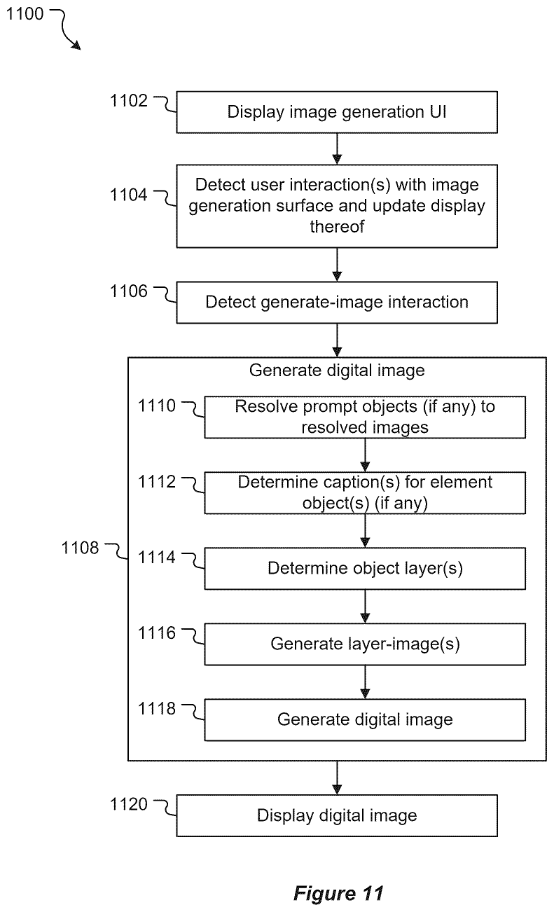

Methods 400 and 900 as described above operate to generate a digital image in real time (or near real time). That is, as a user interacts with the surface 304 (e.g. by adding objects and/or interacting with existing objects) processing is performed to continually generate and display new digital images in accordance with the user interactions. Turning to FIG. 11, an alternative method 1100 for generating a digital image will be described. In method 1100, rather than automatically generating and displaying new digital images as a user interacts with the surface 304, the system is configured to generate and display a digital image only in response to a specific user command to do so (referred to as a generate-image interaction).

At 1102, client application 132 displays an image generation UI. The image generation UI includes a virtual generation surface such as 304 described above. Client application 132 may also (concurrently) display an image preview region such as 306 in the image generation UI but need not do so.

At 1104, one or more user interactions with the image surface 304 are detected. These may include one or more add-object interactions as described at 404 above and/or one or more edit object interactions as described at 902 above. In response to detecting a user interaction with the virtual generation surface, client application 132 updates the display of the virtual generation surface in accordance with the user interaction. E.g. for an add-object user interaction the surface 304 is updated as described at 406 to display the object that is added, and for an edit-object interaction the surface 304 is updated as described at 904.

At 1106, client application 132 detects a generate-image user interaction. This may, for example, be user input activating a generate image control such as control 328.

As generally indicated at 1108, In response to detecting the generate-image user interaction client application 132 generates a digital image based on the state of the surface 304 at the time generate-image user interaction is detected: that is based on the objects that are on the surface 304 (and their positions on the surface 304). Generation of the digital image at 1108 involves processing blocks 1110 to 1118.

At 1110, each prompt object that has been added to the surface 304 (if any) is resolved into a resolved image. Processing to resolve a prompt object to a resolved image may be the same as (or similar to) the processing described above—e.g. by using the prompt to generate a new image (as described with reference to method 600) or using the prompt to retrieve an existing image.

At 1112, a caption is determined for each element object that has been added to the surface 304. Processing to determine the caption for an element object may be the same as (or similar to) the processing described above with reference to processing block 412.

At 1114, a layer is determined for each object that has been added to the surface 304. The processing performed to determine the layer for an object may be the same as (or similar to) the processing described above with reference to processing block 414.

At 1116, a layer-image is generated for each relevant predefined layer. In this context, a relevant predefined layer is a predefined layer that has at least one object assigned to it. In embodiments where text objects are assigned to a text layer, and the digital design is generated with editable text-type design elements corresponding to each text object, the text layer is not a relevant layer (and does not have a layer-image generated for it). Processing to generate a layer-image for a relevant predefined layer may be the same as (or similar to) the processing described above with reference to method 700.

At 1118, a digital image is generated based on the layer-images generated at 1116 (and, where relevant, any text objects). Processing to generate the new digital image may be the same as (or similar to) the processing described above with reference to processing block 420.

At 1120, the digital image generated at 1118 is displayed. Processing to display the new digital image may be the same as (or similar to) the processing described above with reference to processing block 422. In embodiments where the design generation UI initially includes a preview region such as 306 (displayed concurrently with the design surface 304), client application 132 displays the digital image that is generated in the preview region 306. In embodiments in which the design generation UI does not initially include a preview region, displaying the design includes displaying a preview region such as 306. In this case the preview region 306 may be displayed together with the surface 304 (i.e. so both are visible at the same time). Alternatively, the preview region 306 may be displayed instead of the design surface 304. In this case the preview region 306 may include a control which, if activated, causes client application 132 to re-display the design surface 304.

Once the digital image has been displayed, a user may interact further with the image (e.g. as described above) and/or the surface 304 (e.g. to add further objects or edit objects, before performing a generate-image user interaction to generate a new image based on an updated surface 304).

The above embodiments facilitate generation of digital images by adding prompt objects (corresponding to user prompts) and/or element objects (corresponding to actual elements) to a surface 304. In alternative implementations, a system may facilitate generation of digital images by adding prompt objects only to a virtual generation surface, or by adding element objects only.

In the above embodiments, the server application 114 is configured to determine a particular layer for each object that is added to the surface 304 (e.g. at 414) and to generate a separate layer-image for each relevant layer (e.g. at 418). In alternative embodiments, a system may be configured to operate without determining different layers for objects and generating separate layer-images for those layers. In this case all objects that are added to the surface 304 are (effectively) treated as being on the same single layer and generation of a layer-image for that layer is generation of the digital image corresponding to the surface 304 (as there is no need to combine different layer-images and/or text objects).

The following sets of numbered clauses describe additional, specific embodiments of the disclosure.

### Clause Set 1:

Clause 1. A computer implemented method including:
determining a first set of objects, wherein each object in the first set of objects is associated with an object-image and a position;
processing the first set of objects to generate a first image-raster, wherein the first image-raster incorporates each object-image that is associated with an object in the first set of objects and each object-image is positioned in the first image-raster based on the position of the object that the object-image is associated with; and
generating a first digital image, wherein generating the first digital image includes processing the first image-raster using a first machine learning model, and wherein the first machine learning model is a trained image generation model.

Clause 2. The computer implemented method of clause 1, wherein:
the method further includes generating a first image generation prompt based on the first image-raster; and generating the first digital image includes processing the first image-raster and the first image generation prompt using the first machine learning model.

Clause 3. The computer implemented method of clause 2, wherein:
each object in the first set of objects is associated with an object-caption;
and the method further includes processing the first set of objects to generate a first text-raster, wherein the first text-raster incorporates each object-caption that is associated with an object in the first set of objects and each object-caption is positioned in the first text-raster based on the position of the object that the object-caption is associated with; and
the first image generation prompt is generated based on the first image-raster and the first text-raster.

Clause 4. The computer implemented method of any one of clauses 1 to 3, further including:
determining a set of text objects, wherein each text object in the set of text objects is associated with a position;
processing the set of text objects to generate a corresponding set of text-type design elements, wherein the set of text-type design elements includes a text-type design element corresponding to each text object in the set of text objects, and each text-type design element includes position data that is based on the position of the text object the text-type design element corresponds to; and
generating a final digital image based on the first digital image and the set of text-type design elements.

Clause 5. The computer implemented method of any one of clauses 1 to 3, further including:
determining a second set of objects, wherein each object in the second set of objects is associated with an object-image and a position;
processing the second set of objects to generate a second image-raster, wherein the second image-raster incorporates each object-image that is associated with an object in the second set of objects and each object-image is positioned in the second image-raster based on the position of the object that the object-image is associated with;
generating a second digital image, wherein generating the second digital image includes processing the second image-raster using the first machine learning model; and
generating a final digital image based on the first digital image and the second digital image.

Clause 6. The computer implemented method of clause 5, wherein:
the method further includes generating a second image generation prompt based on the second image-raster; and
generating the second digital image includes processing the second image-raster and the second image generation prompt using the first machine learning model.

Clause 7. The computer implemented method of clause 5 or clause 6, wherein:
the first set of objects is associated with a first predefined layer that is associated with a first layer depth;
the second set of objects is associated with a second predefined layer that is associated with a second layer depth; and
the final digital image is generated by composing the first digital image and the second digital image together in a depth order that is based on the first and second layer depths.

Clause 8. The computer implemented method of clause 7, further including:
determining a set of text objects, wherein each text object in the set of text objects is associated with a position and an object depth;
processing the set of text objects to generate a corresponding set of text-type design elements, wherein:
   the set of text-type design elements includes a text-type design element corresponding to each text object in the set of text objects;
   each text-type design element is associated with position data that is based on the position of the text object that the text-type design element corresponds to; and
   each text-type design element is associated with an element depth that is based on the object depth of the text object that the text-type design element corresponds to,
and wherein the final digital image is generated by composing the first digital image, the second digital image, and the set of text-type design elements together in a depth order that is based on the first layer depth, the second layer depth, and the element depth associated with each text-type design element.

Clause 9. The computer implemented method of any one of clauses 1 to 8, wherein:
the first set of objects includes a first object;
the first object is a prompt object that is associated with first prompt text and a first position; and
the method further includes determining a first object-image for the first object based on the first prompt text.

Clause 10. The computer implemented method of clause 9, wherein determining the first object-image includes using the first prompt text to identify and retrieve an existing image.

Clause 11. The computer implemented method of clause 9, wherein determining the first object-image includes generating a new image based on the first prompt text.

Clause 12. The computer implemented method of clause 11, wherein generating the new image includes:
generating a second image generation prompt based on the first prompt text; and
processing the second image generation prompt using a second machine learning model, wherein the second machine learning model is a trained image generation model.

Clause 13. The computer implemented method of clause 12, wherein generating the second image generation prompt includes:
generating a prompt-expansion prompt based on the first prompt text; and
generating the second image generation prompt by processing the prompt-expansion prompt using a third machine learning model, wherein the third machine learning model is a trained text generation model.

Clause 14. The computer implemented method of any one of clauses 11 to 13, wherein generating the new image includes:
generating an initial version of the new image based on the first prompt text; and
generating the new image by removing a background of the initial version of the new image.

Clause 15. The computer implemented method of any one of clauses 12 to 14, wherein the first machine learning model and the second machine learning model are the same machine learning model.

Clause 16. The computer implemented method of any one of clauses 1 to 15, wherein:
the first set of objects includes a second object;
the second object is an image object that is associated with a second object-image; and
the second object-image is an existing image.

Clause 17. The computer implemented method of clause 16, further including processing the existing image to generate a second object-caption for the second object, wherein the second object-caption includes text describing a subject of the existing image.

Clause 18. The computer implemented method of any one of clauses 1 to 17, further including causing the first digital image to be displayed on a display screen.

Clause 19. The computer implemented method of any one of clauses 4 to 8, further including causing the final digital image to be displayed on a display screen.

Clause 20. The computer implemented method of any one of clauses 1 to 19, wherein the first set of objects is determined from a superset of objects, the superset of objects including a plurality of objects that are positioned on a virtual generation surface that is displayed on a display screen.

### Clause Set 2:

Clause 1. A computer implemented method including:
displaying, on a display, a user interface including a virtual generation surface;
detecting a first user interaction adding a first object to the virtual generation surface at a first position, wherein the first object is a prompt object and the first user interaction includes user input that defines first prompt text for the first object;
resolving the first object to a first resolved image based on the first prompt text;
generating a first layer-image based on the first resolved image, wherein the first layer-image includes first image content that corresponds to the first resolved image, and wherein the first image content is positioned in the first layer-image at a position that is based on the first position of the first object on the virtual generation surface.

Clause 2. The computer implemented method of clause 1, wherein generating a first layer-image includes:
determining a first set of objects that belong to a first predefined layer, wherein:
each object in the first set of objects is associated with an object-image and a position on the virtual generation surface; and
the first set of object includes the first object which is associated with the first resolved image;
processing the first set of objects to generate an image-raster, wherein the image-raster incorporates each object-image that is associated with an object in the first set of objects and each object-image is positioned in the image-raster based on the position of the object that the object-image is associated with;
generating a layer-image generation prompt, wherein the layer-image generation prompt is generated based on the image-raster; and
generating the first layer-image by processing the image-raster and the layer-image generation prompt using a trained image generation machine learning model.

Clause 3. The computer implemented method of clause 2, wherein:
each object in the first set of objects is associated with an object-caption;
the method further includes processing the first set of objects to generate a text-raster, wherein the text-raster incorporates each object-caption that is associated with an object in the first set of objects and each object-caption is positioned in the text-raster based on the position of the object that the object-caption is associated with; and
the layer-image generation prompt is generated based on the image-raster and the text-raster.

Clause 4. The computer implemented method of any one of clauses 1 to 3, wherein resolving the first object to the first resolved image includes using the first prompt text to identify and retrieve an existing image.

Clause 5. The computer implemented method of any one of clauses 1 to 3, wherein resolving the first object to the first resolved image includes generating a new image based on the first prompt text.

Clause 6. The computer implemented method of clause 5, wherein generating the new image includes:
generating a first image generation prompt based on the first prompt text; and
processing the first image generation prompt using a first machine learning model, wherein the first machine learning model is a trained image generation model.

Clause 7. The computer implemented method of clause 6, wherein generating the first image generation prompt includes:
generating a prompt-expansion prompt based on the first prompt text; and
generating the first image generation prompt by processing the prompt-expansion prompt using a second machine learning model, wherein the second machine learning model is a trained text generation model.

Clause 8. The computer implemented method of any one of clauses 5 to 7, wherein generating the new image includes:
generating an initial version of the new image based on the first prompt text; and
generating the new image by removing a background of the initial version of the new image.

Clause 9. The computer implemented method of any one of clauses 1 to 6, wherein:
a second object is positioned on the design generation surface at a second position;
the second object is associated with a second object-image; and
the first layer-image is generated based on the first resolved image and the second object-image, wherein the first layer-image includes second image content that corresponds to the second object-image and the second image content is positioned in the first layer-image at a position that is based on the second position of the second object on the virtual generation surface.

Clause 10. The computer implemented method of clause 9, wherein:
the second object is a prompt object and is associated with second prompt text; and
the method further includes processing the second prompt text to generate the second object-image.

Clause 11. The computer implemented method of any one of clauses 1 to 10, wherein:
a third object is positioned on the design generation surface at a third position;
the third object is associated with a third object-image; and
the method further includes:
   determining that the first object belongs to a first predefined layer;
   determining that the third object belongs to a second predefined layer that is different to the first predefined layer;
   generating a second layer-image based on the third object-image, wherein the second layer-image includes third image content that corresponds to the third object-image, and wherein the third image content is positioned in the second layer-image at a position that is based on the third position of the third object on the virtual generation surface; and
   generating a final digital image based on the first layer-image and the second layer-image.

Clause 12. The computer implemented method of clause 11, wherein:
the first predefined layer is associated with a first layer depth;
the second predefined layer is associated with a second layer depth; and
the final digital image is generated by composing the first layer-image and the second layer-image together in a depth order that is based on the first and second layer depths.

Clause 13. The computer implemented method of clause 12, wherein:
a fourth object is positioned on the design generation surface at a fourth position;
the fourth object is a text object that is associated with an object depth;
the method further includes processing the fourth objects to generate a corresponding text-type design element, wherein the text-type design element is associated with position data that is based on the fourth position an element depth that is based on the object depth; and
the final digital image is generated by composing the first layer-image, the second layer-image, and the text-type design element together in a depth order that is based on the first layer depth, the second layer depth, and the element depth associated with the text-type design element.

Clause 14. The computer implemented method of any one of clauses 11 to 13, further including displaying the final digital image.

Clause 15. The computer implemented method of any one of clauses 1 to 14, further including displaying the first layer-image.

### Clause Set 3:

Clause 1. A computer implemented method including:
determining a first set of images, wherein each image in the first set of images is associated with a position;
processing the first set of images to generate a first image-raster, wherein the first image-raster incorporates each image in the first set of images and each image in the first set of images is positioned in the first image-raster based on its associated position;
generating a first image generation prompt, wherein the first image generation prompt is generated based on the first image-raster; and
generating a first digital image, wherein generating the first digital image includes processing the first image-raster and the first image generation prompt using a trained image generation machine learning model.

### Clause Set 4:

Clause 1. A computer processing system including:
one or more processing units; and
one or more non-transitory computer-readable storage media storing instructions, which when executed by the processing unit, cause the one or more processing units to perform a method according to: any one of clauses 1 to 20 of clause set 1; any one of clauses 1 to 14 of clause set 2; and/or clause 1 of clause set 3.

Clause 2. One or more non-transitory storage media storing instructions executable by one or more processing units to cause the one or more processing units to according to: any one of clauses 1 to 20 of clause set 1; any one of clauses 1 to 14 of clause set 2; and/or clause 1 of clause set 3.

In the above embodiments certain operations are described as being performed by the client system 130 (e.g. under control of the client application 132) and other operations are described as being performed at the server environment 110. Variations are, however, possible. For example in certain cases an operation described as being performed by client system 130 may be performed at the server environment 110 and, similarly, an operation described as being performed at the server environment 110 may be performed by the client system 130. Generally speaking, however, where user input is required such user input is initially received at client system 130 (by an input device thereof). Data representing that user input may be processed by one or more applications running on client system 130 or may be communicated to server environment 110 for one or more applications running on the server hardware 112 to process. Similarly, data or information that is to be output by a client system 130 (e.g. via display, speaker, or other output device) will ultimately involve that system 130. The data/information that is output may, however, be generated (or based on data generated) by client application 132 and/or the server environment 110 (and communicated to the client system 130 to be output).

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

In some instances the present disclosure and/or claims may use the terms “first,” “second,” etc. to identify and distinguish between elements or features. When used in this way, these terms are not used in an ordinal sense and are not intended to imply any particular order. For example, when the terms “first” etc are used to differentiate features, a first feature could equally be referred to a second feature without departing from the scope of the described examples. Furthermore, when the terms “first” etc are used to differentiate features a second feature could exist without a first feature or a second feature could occur before a first feature.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method including:
determining, by one or more computer processing devices, a first set of objects, wherein each object in the first set of objects is associated with an object-image and a position;
processing, by the one or more computer processing devices, the first set of objects to generate a first image-raster, wherein the first image-raster incorporates each object-image that is associated with an object in the first set of objects and each object-image is positioned in the first image-raster based on the position of the object that the object-image is associated with; and
generating a first digital image, wherein generating the first digital image includes processing the first image-raster using a first machine learning model, and wherein the first machine learning model is a trained image generation model.

2. The computer implemented method of claim 1, wherein:
the method further includes generating a first image generation prompt based on the first image-raster; and
generating the first digital image includes processing the first image-raster and the first image generation prompt using the first machine learning model.

3. The computer implemented method of claim 2, wherein:
each object in the first set of objects is associated with an object-caption;
the method further includes processing the first set of objects to generate a first text-raster, wherein the first text-raster incorporates each object-caption that is associated with an object in the first set of objects and each object-caption is positioned in the first text-raster based on the position of the object that the object-caption is associated with; and
the first image generation prompt is generated based on the first image-raster and the first text-raster.

4. The computer implemented method of claim 1, further including:
determining a set of text objects, wherein each text object in the set of text objects is associated with a position;
processing the set of text objects to generate a corresponding set of text-type design elements, wherein the set of text-type design elements includes a text-type design element corresponding to each text object in the set of text objects, and each text-type design element includes position data that is based on the position of the text object the text-type design element corresponds to; and
generating a final digital image based on the first digital image and the set of text-type design elements.

5. The computer implemented method of claim 1, further including:
determining a second set of objects, wherein each object in the second set of objects is associated with an object-image and a position;
processing the second set of objects to generate a second image-raster, wherein the second image-raster incorporates each object-image that is associated with an object in the second set of objects and each object-image is positioned in the second image-raster based on the position of the object that the object-image is associated with;
generating a second digital image, wherein generating the second digital image includes processing the second image-raster using the first machine learning model; and
generating a final digital image based on the first digital image and the second digital image.

6. The computer implemented method of claim 5, wherein:
the first set of objects is associated with a first predefined layer that is associated with a first layer depth;
the second set of objects is associated with a second predefined layer that is associated with a second layer depth; and
the final digital image is generated by composing the first digital image and the second digital image together in a depth order that is based on the first and second layer depths.

7. The computer implemented method of claim 1, wherein:
the first set of objects includes a first object;
the first object is a prompt object that is associated with first prompt text and a first position; and
the method further includes identifying an existing image based on the first prompt text and using the existing image as the object-image for the first object.
The computer implemented method of claim 1, wherein:
the first set of objects includes a first object;
the first object is a prompt object that is associated with first prompt text and a first position; and
the method further includes generating a new image based on the first prompt text and using the new image as the object-image for the first object.

9. The computer implemented method of claim 1, further including causing the first digital image to be displayed on a display screen.

10. The computer implemented method of claim 1, wherein the first set of objects is determined from a superset of objects, the superset of objects including a plurality of objects that are positioned on a virtual generation surface that is displayed on a display screen.

11. A computer processing system including:
one or more processing devices; and
one or more non-transitory computer-readable storage media storing instructions, which when executed by the one or more processing devices, cause the one or more processing devices to perform a method including:
determining a first set of objects, wherein each object in the first set of objects is associated with an object-image and a position;
processing the first set of objects to generate a first image-raster, wherein the first image-raster incorporates each object-image that is associated with an object in the first set of objects and each object-image is positioned in the first image-raster based on the position of the object that the object-image is associated with; and
generating a first digital image, wherein generating the first digital image includes processing the first image-raster using a first machine learning model, and wherein the first machine learning model is a trained image generation model.

12. The computer processing system of claim 11, wherein:
the method further includes generating a first image generation prompt based on the first image-raster; and
generating the first digital image includes processing the first image-raster and the first image generation prompt using the first machine learning model.

13. The computer processing system of claim 12, wherein:
each object in the first set of objects is associated with an object-caption;
the method further includes processing the first set of objects to generate a first text-raster, wherein the first text-raster incorporates each object-caption that is associated with an object in the first set of objects and each object-caption is positioned in the first text-raster based on the position of the object that the object-caption is associated with; and
the first image generation prompt is generated based on the first image-raster and the first text-raster.

14. The computer processing system of claim 11, further including:
determining a set of text objects, wherein each text object in the set of text objects is associated with a position;
processing the set of text objects to generate a corresponding set of text-type design elements, wherein the set of text-type design elements includes a text-type design element corresponding to each text object in the set of text objects, and each text-type design element includes position data that is based on the position of the text object the text-type design element corresponds to; and
generating a final digital image based on the first digital image and the set of text-type design elements.

15. The computer processing system of claim 11, further including:
determining a second set of objects, wherein each object in the second set of objects is associated with an object-image and a position;
processing the second set of objects to generate a second image-raster, wherein the second image-raster incorporates each object-image that is associated with an object in the second set of objects and each object-image is positioned in the second image-raster based on the position of the object that the object-image is associated with;
generating a second digital image, wherein generating the second digital image includes processing the second image-raster using the first machine learning model; and
generating a final digital image based on the first digital image and the second digital image.

16. The computer processing system of claim 15, wherein:
the first set of objects is associated with a first predefined layer that is associated with a first layer depth;
the second set of objects is associated with a second predefined layer that is associated with a second layer depth; and
the final digital image is generated by composing the first digital image and the second digital image together in a depth order that is based on the first and second layer depths.

17. The computer processing system of claim 11, wherein:
the first set of objects includes a first object;
the first object is a prompt object that is associated with first prompt text and a first position; and
the method further includes generating a new image based on the first prompt text and using the new image as the object-image for the first object.

18. The computer processing system of claim 11, further including causing the first digital image to be displayed on a display screen.

19. The computer processing system of claim 11, wherein the first set of objects is determined from a superset of objects, the superset of objects including a plurality of objects that are positioned on a virtual generation surface that is displayed on a display screen.

20. One or more non-transitory storage media storing instructions executable by one or more processing devices to cause the one or more processing devices to perform a method including:
determining a first set of objects, wherein each object in the first set of objects is associated with an object-image and a position;
processing the first set of objects to generate a first image-raster, wherein the first image-raster incorporates each object-image that is associated with an object in the first set of objects and each object-image is positioned in the first image-raster based on the position of the object that the object-image is associated with; and
generating a first digital image, wherein generating the first digital image includes processing the first image-raster using a first machine learning model, and wherein the first machine learning model is a trained image generation model.
